(19) United States
(12) Patent Application Publication
(10) Pub. No.: US 2009/0092431 A1
(43) Pub. Date: Apr. 9, 2009

(54) Image forming system and image forming apparatus

(75) Inventor: Yasushi Saitsu, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 12/150,457

(22) Filed: Apr. 28, 2008

(30) Foreign Application Priority Data
Oct. 3, 2007 (JP) 2007-259951

(51) Int. Cl. G03G 15/00

(52) U.S. Cl. 399/407

(57) ABSTRACT

Disclosed is an image forming system comprising: an instruction section to perform an instruction for an image formation; an image forming section to form the image for paper based on the instruction; a first post-processing apparatus to perform first post-processing for the image formed paper based on the instruction; a second post-processing apparatus to perform second post-processing for the paper based on the instruction; a first reverse apparatus including a reverse mechanism to convey the paper from the image forming section to the first post-processing apparatus and to perform a reverse of the conveyed paper; a second reverse apparatus including a reverse mechanism to convey the paper from the first post-processing apparatus to the second post-processing apparatus and to perform the reverse of the conveyed paper; and a control section to control the reverse of the paper in the first and the second reverse apparatus based on the instruction.

### BACKGROUND OF THE INVENTION

1. Field of the Invention

The present invention relates to an image forming system and an image forming apparatus.

2. Description of Related Art

There have conventionally been image forming apparatus and image forming systems that perform post-processing for pieces of paper after image formation thereon, such as punching processing and stapling processing, and the like. It is known that some of the image forming apparatus and the image forming systems have a reverse mechanism to reverse the front and the back of a sheet of paper that is conveyed after image formation thereon in order to change the position of post-processing on the paper. For example, Japanese Patent Application Laid-Open Publication No. 11-268855 discloses an image forming apparatus including a paper reversing mechanism.

Moreover, some of the conventional image forming apparatus and the image forming systems mentioned above select the post-processing to be performed among a plurality of kinds of post-processing. For example, Japanese Patent Application Laid-Open Publication No. 11-258882 discloses an image forming system capable of selecting two types of post-processing.

However, the related art mentioned above does not include a plurality of reverse mechanisms corresponding to each type of post-processing, and selects either of two types of post-processing to perform the selected one. Consequently, it has been impossible to perform two types of prost-processing to the same sheet of paper.

Because two types of prost-processing cannot be performed to the same sheet of paper as mentioned above, when two types of post-processing are to be performed for a sheet of paper or a sheaf of papers, the related art must perform a type of the post-processing first and then perform another type of post-processing with another processing machine that is not connected to the image forming apparatus or the system. Consequently, the related art has burdened a user with a large load.

### SUMMARY OF THE INVENTION

According to one aspect of the present invention, there is provided an image forming system comprising:

an instruction section to perform an instruction pertaining to an image formation;

an image forming section to perform the image formation for a sheet of paper based on the instruction by the instruction section;

a first post-processing apparatus to perform first post-processing for the paper after the image formation by the image forming section, based on the instruction by the instruction section;

a second post-processing apparatus to perform second post-processing for the paper based on the instruction by the instruction section, the paper having been through the first post-processing apparatus;

a first reverse apparatus including a reverse mechanism to convey the paper from the image forming section to the first post-processing apparatus and to perform a reverse of the conveyed paper;

a second reverse apparatus including a reverse mechanism to convey the paper from the first post-processing apparatus to the second post-processing apparatus and to perform the reverse of the conveyed paper; and

a control section to control the reverse of the paper in the first reverse apparatus and in the second reverse apparatus based on contents of the instruction by the instruction section.

According to another aspect of the present invention, there is provided an image forming apparatus comprising:

an instruction section to perform an instruction pertaining to an image formation;

an image forming section to perform the image formation for a sheet of paper based on the instruction by the instruction section;

a first post-processing section to perform first post-processing for the paper after the image formation by the image forming section, based on the instruction by the instruction section;

a second post-processing section to perform second post-processing for the paper based on the instruction by the instruction section, the paper having been through the first post-processing section;

a first reverse section including a reverse mechanism to convey the paper from the image forming section to the first post-processing section and to perform a reverse of the conveyed paper;

a second reverse section including a reverse mechanism to convey the paper from the first post-processing section to the second post-processing section and to perform the reverse of the conveyed paper; and

a control section to control the reverse of the paper in the first reverse section and in the second reverse section based on contents of the instruction by the instruction section.

According to the aspects mentioned above, it is possible to control the front-back reversing of a sheet of paper in a first reverse apparatus to perform the front-back reversing of the paper when the paper is conveyed to the first post-processing apparatus and the front-back reversing of the paper in a second reverse apparatus to perform the front-back reversing of the paper when the paper is conveyed to the second post-processing apparatus on the basis of an instruction pertaining to image information by an instruction section. Further, it is also possible to perform the post-processing by the first and second post-processing apparatus at the same time. Consequently, even when a plurality of types of post-processing are performed, the work load of a user can be reduced, and working efficiency of the user is improved.

### BRIEF DESCRIPTION OF THE DRAWINGS

These and other objects, advantages and features of the present invention will become more fully understood from the detailed description given hereinbelow and the appended drawings and thus are not intended as a definition of the limits of the present invention, and wherein;

FIG. 1 is a schematic view showing the configuration of an image forming system according to the present embodiment;

FIG. 2 is a block diagram schematically showing the functional configuration of the image forming system;

FIG. 3 is a flowchart showing the processing pertaining to the reverse control of a sheet of paper in the image forming system;

FIG. 4 is a flowchart showing a continuation of the flowchart of FIG. 3;

FIG. 5 is a flowchart showing another continuation of the flowchart of FIG. 3;

FIG. 6 is a flowchart showing a further continuation of the flowchart of FIG. 3;

FIG. 7 is a flowchart showing a still further continuation of the flowchart of FIG. 3;

FIG. 8 is a flowchart showing a still further continuation of the flowchart of FIG. 3;

FIG. 9 is a flowchart showing a continuation of the flowchart of FIG. 8;

FIG. 10 is a conceptual diagram to illustrate a case of a sheet of paper after image formation in the image forming system;

FIG. 11 is a conceptual diagram to illustrate a case of another sheet of paper after image formation in the image forming system;

FIG. 12 is a conceptual diagram to illustrate a case of a further sheet of paper after image formation in the image forming system;

FIG. 13 is a conceptual diagram to illustrate a case of a still further sheet of paper after image formation in the image forming system;

FIG. 14 is a conceptual diagram to illustrate a case of a still further sheet of paper after image formation in the image forming system;

FIG. 15 is a conceptual diagram to illustrate a case of a still further sheet of paper after image formation in the image forming system;

FIG. 16 is a conceptual diagram to illustrate a case of a still further sheet of paper after image formation in the image forming system;

FIG. 17 is a conceptual diagram to illustrate a case of a still further sheet of paper after image formation in the image forming system;

FIG. 18 is a conceptual diagram to illustrate a case of a still further sheet of paper after image formation in the image forming system;

FIG. 19 is a conceptual diagram to illustrate a case of a still further sheet of paper after image formation in the image forming system;

FIG. 20 is a conceptual diagram to illustrate a case of a still further sheet of paper after image formation in the image forming system;

FIG. 21 is a conceptual diagram to illustrate a case of a still further sheet of paper after image formation in the image forming system;

FIG. 22 is a conceptual diagram to illustrate a case of a still further sheet of paper after image formation in the image forming system;

FIG. 23 is a conceptual diagram to illustrate a case of a still further sheet of paper after image formation in the image forming system;

FIG. 24 is a conceptual diagram to illustrate a case of a still further sheet of paper after image formation in the image forming system;

FIG. 25 is a conceptual diagram to illustrate a case of a still further sheet of paper after image formation in the image forming system;

FIG. 26 is a conceptual diagram to illustrate a case of a still further sheet of paper after image formation in the image forming system;

FIG. 27 is a conceptual diagram to illustrate a case of a still further sheet of paper after image formation in the image forming system; and

FIG. 28 is a conceptual diagram to illustrate a case of a still further sheet of paper after image formation in the image forming system.

### DETAILED DESCRIPTION OF THE PREFERRED EMBODIMENTS

In the following, the preferred embodiments of the present invention will be described with reference to the attached drawings, but the present invention is not limited to the following embodiments. Moreover, the embodiments of the present invention are the most preferable modes of the invention, and are not intended to limit the scope of the invention.

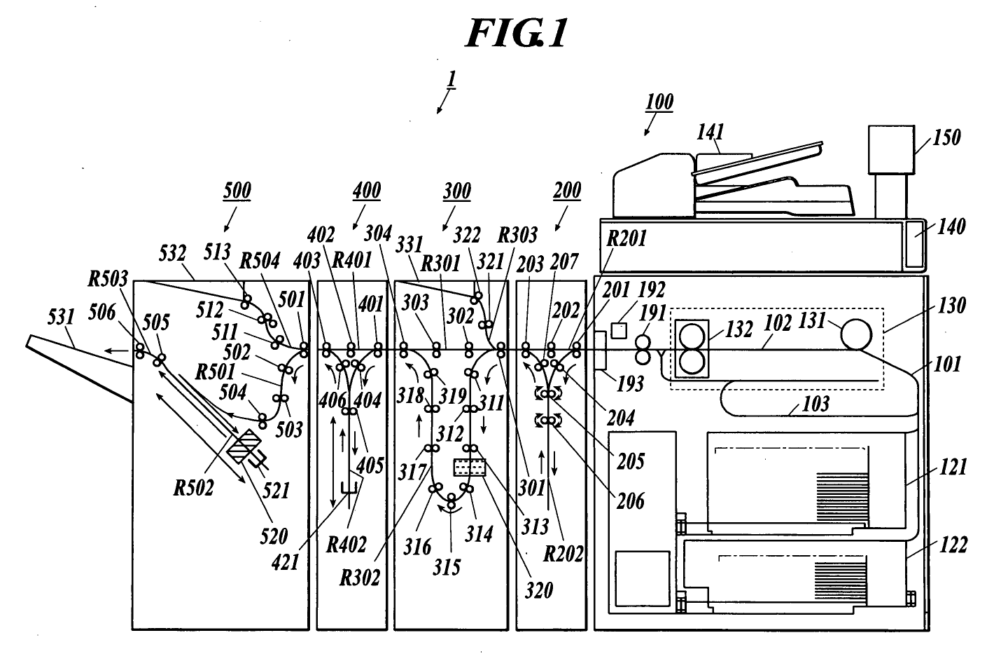

The configuration of an image forming system according to the present embodiment will be first described. As shown in FIG. 1, an image forming system 1 comprises an image forming apparatus main body 100, a first reverse apparatus 200, a first post-processing apparatus 300, a second reverse apparatus 400, and a second post-processing apparatus 500.

The image forming apparatus main body 100 comprises housing sections 121 and 122, an image forming section 130, an image reading section 140, an automatic document conveying section 141, a display/operation section 150, paper ejecting rollers 191, a paper ejection sensor 192, a paper ejecting port 193, and the like. Moreover, the image forming apparatus main body 100 is provided with a conveyance path 101 along which paper feeding is performed from the housing sections 121 and 122 to the image forming section 130, a conveyance path 102 from the image forming section 130 to the paper ejecting port 193 through the paper ejecting rollers 191, and a conveyance path 103 to perform the front-back reversing of a sheet of paper, as the conveyance paths of a sheet of paper.

The housing sections 121 and 122 each house the same assortment of sheets of paper before image formation by the paper assortment, such as the paper type and the paper size. As the assortments of the paper to be housed in the housing sections 121 and 122, to put it concretely, there are tabbed paper with a tab on its one side in the lengthwise direction thereof, plain paper to have no specific tabs, backing paper, recycled paper, paper of fine quality, thick paper, and the like.

The image forming section 130 performs the exposure scanning of a photosensitive body 131 with a laser beam emitted from an exposure section (not shown) on the basis of image data to form an electrostatic latent image. The image forming section 130 next makes the photosensitive body 131 absorb toner in the development section (not shown), and transfers the toner to a sheet of paper in a transfer section (not shown). The image forming section 130 then forms an image by performing the heat fixing of the toner to the paper in a fixing section 132. The image forming section 130 may perform image formation on paper by the ink-jet system, the thermal transfer system, or the like, although the configuration of performing the image formation on paper by the so-called electrophotographic printing process is illustrated as described above.

The image reading section 140 is a function section to read a document placed on a reading tray or the like as image data. To put it concretely, a light from a light source is radiated to a document placed on a reading stand (not shown), and a reflected light reflected from the document is read by a charge coupled device (CCD). When the automatic document conveying section 141 is used, then a document is conveyed from a sheaf of documents set in the automatic document conveying section 141 to the reading stand of the image reading section 140 one by one, and the image formed on the document is read.

The display/operation section 150 as an instruction section is provided with various operation keys, such as numeric keys, a start key, function keys to perform various settings pertaining to image formation, and the like. Moreover, the display/operation section 150 is provided with a touch panel to be integrally formed with a display screen, such as a liquid crystal display (LCD). The touch panel detects a position against which the tip of a finger of a user, a touch pen, or the like, abuts, and receives an operation instruction from the user.

With the image forming system 1, a user can perform an instruction pertaining to image formation and various settings in the image forming system 1 by operating an operation key or the touch panel of the display/operation section 150. Moreover, the image forming system 1 can inform a user of the operating state and the like of the image forming system 1 by displaying the operating conditions and various kinds of setting status of the image forming system 1 in the display/operation section 150.

The instruction pertaining to image formation with the display/operation section 150 includes the instructions pertaining to image formation onto both sides or one side of a sheet of paper, a paper assortment of a sheet of paper on which image formation is to be performed (such as the size thereof and the existence of a tab, and the like), an assortment of the post-processing to be performed to the paper after image formation (such as stapling and punching holes, and the like), an ejected paper surface at the time of ejecting paper to the outside of the machine, and the like.

The ejected paper surface here indicates the top surface of a sheet of paper that has been ejected to the outside of the machine and has been placed on the tray. For example, the ejected paper surface is a face up in the case where a sheet of paper is placed on the tray in the state in which the surface on which image formation has been performed as the front surface of the paper is made to be the front thereof. Moreover, the ejected paper surface is a face down in the case where a sheet of paper is placed on the tray in the state in which the surface on which image formation has been performed as the front surface of the paper is made be the back thereof.

The paper ejecting rollers 191 perform rotation driving by a drive source (not shown), such as a motor. The paper ejecting rollers 191 convey a sheet of paper on which image formation has been performed to the paper ejecting port 193 by performing the rotation driving. The paper ejection sensor 192 is a sensor to detect the existence of paper. The paper ejection sensor 192 is installed in the neighborhood of the paper ejecting port 193, and performs the detection of the positions of both the leading edge side and the rear edge side of a sheet of paper that is ejected from the paper ejecting port 193 in the conveyance direction of the paper.

The first reverse apparatus 200 is installed between the image forming apparatus main body 100 and the first post-processing apparatus 300. The first reverse apparatus 200 includes conveyance rollers 201-207 each connected to a drive source (not shown), such as a motor, in order to convey a sheet of paper. The first reverse apparatus 200 receives a sheet of paper after image formation ejected from the image forming apparatus main body 100 and conveys the paper to the first post-processing apparatus 300 by means of the conveyance rollers 201-207.

As the conveyance courses of paper in the first reverse apparatus 200, there are a conveyance path R201 along which a sheet of paper is conveyed in the order of conveyance rollers 201, 202, and 203, and a conveyance path R202 along which a sheet of paper is conveyed in the order of conveyance rollers 201, 204, 205, 206, 207, and 203.

The conveyance path R201 is a course along which a sheet of paper is conveyed from the image forming apparatus main body 100 to the first post-processing apparatus 300 directly without performing front-back reversing. The first reverse apparatus 200 can convey a sheet of paper to the first post-processing apparatus 300 without reversing the front-back state of the paper ejected from the image forming apparatus main body 100 in such a way by conveying the paper through the conveyance path R201.

The conveyance path R202 is a course as a reverse mechanism to once draw in a sheet of paper from the leading edge side thereof in the conveyance direction and to perform the front-back reversing of the paper at the time of drawing out the paper from the rear edge side thereof in the case of conveying the paper from the image forming apparatus main body 100 to the first post-processing apparatus 300. The first reverse apparatus 200 can convey a sheet of paper ejected from the image forming apparatus main body 100 to the first post-processing apparatus 300 with the front-back state of the paper reversed by conveying the paper through the conveyance path R202 as the reverse mechanism of paper in such a way.

The first post-processing apparatus 300 is installed through the image forming apparatus main body 100 and the first reverse apparatus 200, and performs the post-processing of the paper after image formation by the image forming apparatus main body 100. Moreover, the second reverse apparatus 400 is installed successively to the first post-processing apparatus 300, and the paper after the post-processing is ejected to the second reverse apparatus 400.

The first post-processing apparatus 300 includes conveyance rollers 301-304, conveyance rollers 311-319, and conveyance rollers 321 and 322, each connected to a drive source (not shown), such as a motor, in order to convey paper. The first post-processing apparatus 300 further includes a post-processing section 320 and a sub tray 331. The post-processing section 320 performs post-processing (first post-processing) such as punching holes and the like on the leading edge side of a sheet of conveyed paper in the conveyance direction thereof. The sub tray 331 is a tray to accumulate sheets of paper ejected to the outside to be placed thereon.

As the conveyance courses of a sheet of paper in the first post-processing apparatus 300, there are a conveyance path R301 along which the paper is conveyed in the order of conveyance rollers 301, 302, 303, and 304, a conveyance path R302 along which the paper is conveyed in the order of conveyance rollers 301, 311-319, and 304, and a conveyance path R303 along which the paper is conveyed in the order of conveyance rollers 301, 321, and 322.

The conveyance path R301 is a course along which a sheet of paper that has been conveyed from the image forming apparatus main body 100 through the first reverse apparatus 200 is ejected to the second reverse apparatus 400, which is installed successively to the first post-processing apparatus 300, without receiving any the post-processing. The first post-processing apparatus 300 can eject the paper to the second reverse apparatus 400 without performing any post-processing by conveying the paper through the conveyance path R301 in such a way.

The conveyance path R302 is provided with the post-processing section 320 on the way of the course, and the first post-processing mentioned above can be executed to the paper conveyed from the image forming apparatus main body 100 through the first reverse apparatus 200. The first post-processing apparatus 300 can perform the first post-processing to the leading edge side of a sheet of paper in the conveyance direction of the paper at the time of the carrying in of the paper with the post-processing section 320, and can eject the paper to the second reverse apparatus 400 by conveying the paper through the conveyance path R302 in such a way.

The conveyance path R303 is a course along which the paper conveyed from the image forming apparatus main body 100 through the first reverse apparatus 200 is ejected to the sub tray 331 as it is. The first post-processing apparatus 300 can eject the paper after image formation by the image forming apparatus main body 100 to the outside to accumulate the ejected paper on the sub tray 331 by conveying the paper through the conveyance path R303 in such a way.

The second reverse apparatus 400 is installed between the first post-processing apparatus 300 and the second post-processing apparatus 500. The second reverse apparatus 400 includes conveyance rollers 401-406, each connected to a drive source (not shown), such as a motor, in order to convey a sheet of paper, and a reverse stopper 421 to stay a plurality of sheets of paper. The second reverse apparatus 400 receives a sheet of paper ejected from the first post-processing apparatus 300 and conveys the received paper to the second post-processing apparatus 500 by means of the conveyance rollers 401-406.

The reverse stopper 421 sequentially stacks conveyed sheets of paper to stock the paper, and stays a plurality of sheets of paper in the order of conveyance. The second reverse apparatus 400 conveys a sheaf of a plurality of sheets of paper to the second post-processing apparatus 500 when the reverse stopper 421 stays the plurality of sheets of paper.

As the conveyance courses of paper in the second reverse apparatus 400, there are a conveyance path R401 along which a sheet of paper is conveyed in the order of conveyance rollers 401, 402, and 403, and a conveyance path R402 along which a sheet of paper is conveyed in the order of conveyance rollers 401, 404, 405, 406, and 403.

The conveyance path R401 is a course along which paper is conveyed from the first post-processing apparatus 300 to the second post-processing apparatus 500 directly without receiving any front-back reversing. The second reverse apparatus 400 can convey the paper ejected from the first post-processing apparatus 300 to the second post-processing apparatus 500 without reversing the front-back state of the paper by conveying the paper through the conveyance path R401 in such a way.

The conveyance path R402 is a course as a reverse mechanism to once draw in a sheet of paper from the leading edge side of the paper in the conveyance direction thereof and to perform the front-back reversing of the paper at the time of drawing out from the rear edge side of the paper when the paper is conveyed from the first post-processing apparatus 300 to the second post-processing apparatus 500. The second reverse apparatus 400 can convey a sheet of paper ejected from the first post-processing apparatus 300 to the second post-processing apparatus 500 with the front-back state of the paper reversed by conveying the paper through the conveyance path R402 as the reverse mechanism of the paper in such a way.

Moreover, the conveyance path R402 includes the reverse stopper 421, and is adapted to be able to sequentially stock sheets of paper when the paper is once drawn in from the leading edge side thereof in the conveyance direction thereof. The second reverse apparatus 400 can convey a sheaf of a plurality of sheets to the second post-processing apparatus 500 with the front-back state of the sheaf reversed when the second reverse apparatus 400 conveys the paper through the conveyance path R402 to stay the plurality of sheets in the reverse stopper 421.

The second post-processing apparatus 500 is installed through the first post-processing apparatus 300 and the second reverse apparatus 400, and performs post-processing to the paper routed through the first post-processing apparatus 300. The second post-processing apparatus 500 includes conveyance rollers 501-506 and conveyance rollers 511-513, each connected to a drive source (not shown), such as a motor, in order to convey paper. The second post-processing apparatus 500 further includes a post-processing section 520 and a stopper 521. The second post-processing section 500 still further includes a main tray 531 and a sub tray 532, which accumulate the paper ejected to the outside to place thereon.

The post-processing section 520 performs the post-processing (second post-processing), such as stapling and the like, to the rear edge side of the conveyed paper in the conveyance direction. The stopper 521 stays the conveyed paper in the order of the conveyance thereof similarly to the reverse stopper 421. The second post-processing apparatus 500 can execute the second post-processing with the post-processing section 520 to a sheaf of a plurality of sheets of paper when the stopper 521 has stayed the plurality sheets of paper.

As the conveyance courses of paper in the second post-processing apparatus 500, there are conveyance paths R501, R502, and R503, which are courses along which paper is ejected to the main tray 531 by being conveyed in the order of the conveyance rollers 501-506, and a conveyance path R504, which is a course along which paper is ejected to the sub tray 532 by being conveyed in the order of the conveyance rollers 501, and 511-513. The conveyance path R502 is provided with the post-processing section 520 and the stopper 521.

Because the course along which paper is ejected to the main tray 531 is routed through the conveyance path R502, it is possible to execute the second post-processing described above to the paper conveyed from the first post-processing apparatus 300 through the second reverse apparatus 400. The second post-processing apparatus 500 can perform the second post-processing to the rear edge side of paper in the conveyance direction of the paper at the time of being carried in with the post-processing section 520 to eject the paper to the main tray 531 by conveying the paper through the conveyance paths R501, R502, and R503 in such a way.

The conveyance path R50.4, along which paper is ejected to the sub tray 532, is a course along which the paper conveyed from the first post-processing apparatus 300 through the second reverse apparatus 400 is ejected without being subjected to any post-processing. The second post-processing apparatus 500 can eject paper to the outside of the machine without performing any post-processing to the paper by conveying the paper through the conveyance path R504.

Incidentally, the connection layout of each apparatus of the image forming system 1 is not especially limited to the one described above. For example, the installation positions of the first reverse apparatus 200 and the second reverse apparatus 400 may be replaced with each other. That is, the image forming system 1 may be configured so that either of the first reverse apparatus and the second reverse apparatus may include a reverse stopper. Moreover, the image forming system 1 may be configured so that both of the first reverse apparatus and the second reverse apparatus include the reverse stopper.

Moreover, as for the configuration of the post-processing in the image forming system 1, the image forming system 1 may be configured so that the first post-processing apparatus may perform the post-processing to the rear edge side of paper in the conveyance direction thereof, and that the second post-processing apparatus may perform the post-processing to the leading edge side of paper in the conveyance direction thereof. That is, the image forming system 1 may be the one in which the installation positions of the first post-processing apparatus 300 and the second post-processing apparatus 500 are replaced with each other.

Moreover, although the image forming system 1 has a system configuration in which a plurality of apparatus are connected, the image forming system 1 may be configured as an image forming apparatus including each of the plurality of apparatus as a unit.

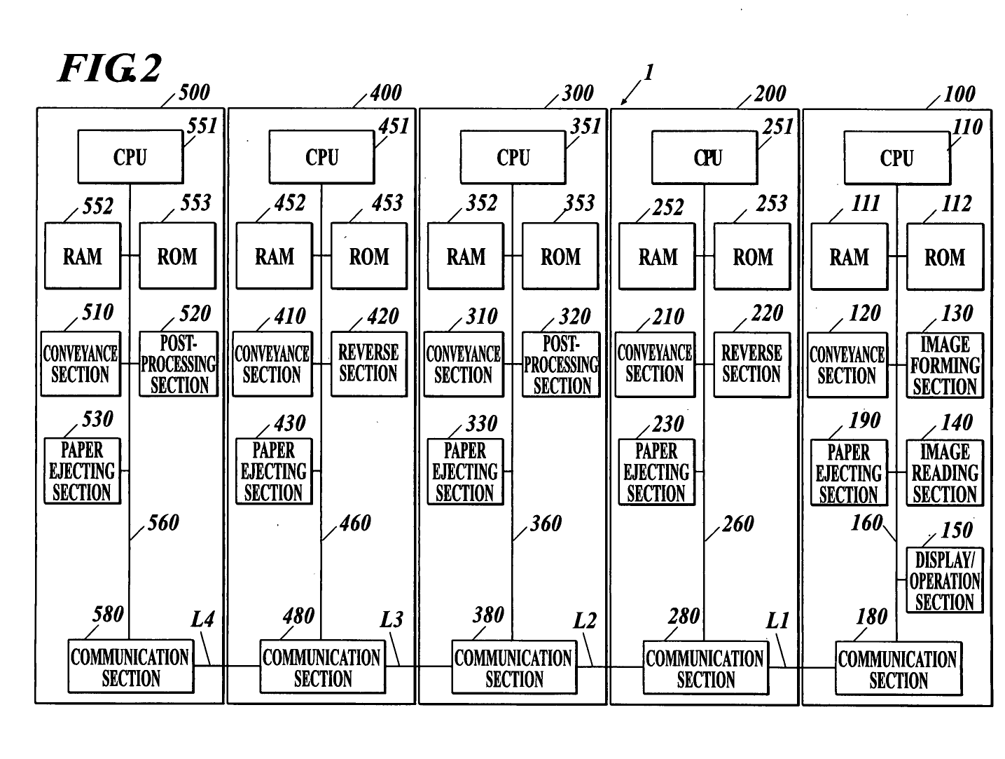

The functional configuration of the image forming system 1 will be described here. As shown in FIG. 2, the image forming apparatus main body 100 and the first reverse apparatus 200 are connected to each other with a communication line L1 in a state capable of communicating with each other. Moreover, the first reverse apparatus 200 and the first post-processing apparatus 300 are connected to each other with a communication line L2 in a state capable of communicating with each other. Moreover, the first post-processing apparatus 300 and the second reverse apparatus 400 are connected to each other with a communication line L3 in a state capable of communicating with each other. Moreover, the second reverse apparatus 400 and the second post-processing apparatus 500 are connected to each other with a communication line L4 in a state capable of communicating with each other.

That is, the image forming system 1 is configured in which the image forming apparatus main body 100, the first reverse apparatus 200, the first post-processing apparatus 300, the second reverse apparatus 400, and the second post-processing apparatus 500 are connected to one another in cascade with the communication lines L1, L2, L3, and L4. Incidentally, the connection layout of the image forming system 1 may be, for example, a star one, and is not especially limited. Moreover, the communications of the image forming system 1 may be the ones using wireless circuits and infrared rays besides the wire communications with the communication lines L1-L4.

The image forming apparatus main body 100 comprises a CPU 110, a RAM 111, a ROM 112, a conveyance section 120, the image forming section 130, the image reading section 140, the display/operation section 150, and a paper ejecting section 190. Each section of the image forming apparatus main body 100 is connected to one another through a bus 160.

The central processing unit (CPU) 110 performs the integrated control of each section of the image forming apparatus main body 100. The CPU 110 expands a specified program data among the various kinds of program data stored in the read only memory (ROM) 112 into the random access memory (RAM) 111, and executes various kinds of processing in cooperation with the program data expanded in the RAM 111.

To put it concretely, the CPU 110 controls the image formation of the image forming section 130 on the basis of an operation instruction pertaining to the image formation, which operation instruction has been input from the display/operation section 150. Moreover, the CPU 110 controls the reverse control (the details of which will be described later) of the paper subjected to the image formation by the image forming section 130, the existence of post-processing, and the like, by outputting a control signal to each apparatus connected to the image forming apparatus main body 100 on the basis of an operation instruction pertaining to the image formation, which operation instruction has been input from the display/operation section 150.

The conveyance section 120 includes the drive sources (not shown), such as motors, to perform driving under the control of the CPU 110, and conveys paper with the conveyance paths 101, 102, and 103 mentioned above. A communication section 180 is a communication interface to perform parallel communications or serial communications through the communication line L1. The paper ejecting section 190 includes the paper ejecting rollers 191, the paper ejection sensor 192, and the paper ejecting port 193, which have been mentioned above, and ejects the paper after the image formation by the image forming section 130 to the outside of the machine.

The first reverse apparatus 200 comprises a CPU 251, a RAM 252, a ROM 253, a conveyance section 210, a reverse section 220, a paper ejecting section 230, and a communication section 280. Each section of the first reverse apparatus 200 is connected to one another through a bus 260.

The CPU 251 performs the integrated control of each section of the first reverse apparatus 200. The CPU 251 expands specified program data among the various kinds of program data stored in the ROM 253 into the RAM 252, and executes various kinds of processing in cooperation with the program data expanded in the RAM 252.

To put it concretely, the CPU 251 performs the control at the time of conveying the paper after image formation which paper being conveyed from the image forming apparatus main body 100 to the first post-processing apparatus 300 on the basis of a control signal from the image forming apparatus main body 100. Moreover, the CPU 251 controls the reverse of a sheet of paper on the basis of a control signal from the image forming apparatus main body 100 at the time of conveying the paper to the first post-processing apparatus 300.

Moreover, the CPU 251 reads the information pertaining to the first reverse apparatus 200 which information has been previously stored in the ROM 253 to transmit the read information to the image forming apparatus main body 100 on the basis of a control signal from the image forming apparatus main body 100. The information pertaining to the first reverse apparatus 200 indicates the set information peculiar to the own apparatus, such as the existence of the reverse stopper in the reverse section 220, and the positional information such as the installation position (indicating what number apparatus the first reverse apparatus 200 is installed from the image forming apparatus main body 100) of the first reverse apparatus 200 in the image forming system 1, and the like.

The conveyance section 210 is the conveyance path R201 mentioned above, and conveys the paper after the image formation which paper ejected from the image forming apparatus main body 100 to the first post-processing apparatus 300 under the control of the CPU 251. The reverse section 220 is the conveyance path R202 mentioned above, and reverses the paper after image formation which paper has been ejected from the image forming apparatus main body 100 to convey the paper to the first post-processing apparatus 300 under the control of the CPU 251. The paper ejecting section 230 is the conveyance rollers 203 to eject paper to the first post-processing apparatus 300, which conveyance rollers 203 has been mentioned above, and ejects the paper to the first post-processing apparatus 300 which is connected to the image forming apparatus main body 100 through the own apparatus, under the control of the CPU 251.

The first post-processing apparatus 300 comprises a CPU 351, a RAM 352, a ROM 353, a conveyance section 310, the post-processing section 320, a paper ejecting section 330, and a communication section 380. Each section of the first post-processing apparatus 300 is connected to one another through a bus 360.

The CPU 351 performs the integrated control of each section of the first post-processing apparatus 300. The CPU 351 expands the specified program data among the various kinds of program data stored in the ROM 353 into the RAM 352, and executes various kinds of processing in cooperation with the program data expanded in the RAM 352.

To put it concretely, the CPU 351 controls the post-processing to the paper after image formation which paper has been conveyed from the image forming apparatus main body 100 through the first reverse apparatus 200 on the basis of a control signal from the image forming apparatus main body 100. Moreover, the CPU 351 reads the information pertaining to the first post-processing apparatus 300 which information has been previously stored in the ROM 353 to transmit the read information to the image forming apparatus main body 100 on the basis of a control signal from the image forming apparatus main body 100.

The information pertaining to the first post-processing apparatus 300 is the set information peculiar to the own apparatus such as the assortment of the post-processing executable in the post-processing section 320 (such as stapling and punching holes) and the execution positions of post-processing in paper (such as the leading edge side/rear edge side in the conveyance direction thereof), and the positional information such as the installation position (indicating what number apparatus the first post-processing apparatus 300 is installed from the image forming apparatus main body 100) of the first post-processing apparatus 300 in the image forming system 1. Incidentally, in the present embodiment, the descriptions will be given on the supposition that the first post-processing apparatus 300 performs the post-processing to the leading edge side of paper in the conveyance direction thereof.

The conveyance section 310 is the conveyance paths R301, R302, and R303 mentioned above, and conveys paper under the control of the CPU 351. The paper ejecting section 330 is the conveyance rollers 304 to eject paper to the sub tray 331 or the second reverse apparatus 400, which have been mentioned above, and performs the ejection of paper to the outside of the machine or the ejection of paper to the second reverse apparatus 400 connected to the own apparatus under the control of the CPU 351.

The second reverse apparatus 400 comprises a CPU 451, a RAM 452, a ROM 453, a conveyance section 410, a reverse section 420, a paper ejecting section 430, and a communication section 480. Each section of the second reverse apparatus 400 is connected to one another through a bus 460.

The CPU 451 performs the integrated control of each section of the second reverse apparatus 400. The CPU 451 expands the specified program data among the various kinds of program data stored in the ROM 453 to the RAM 452, and executes various kinds of processing in cooperation with the program data expanded in the RAM 452.

To put it concretely, the CPU 451 performs the control at the time of conveying the paper conveyed from the first post-processing apparatus 300 to the second post-processing apparatus 500 on the basis of a control signal from the image forming apparatus main body 100. Moreover, the CPU 451 controls the reverse of paper on the basis of a control signal from the image forming apparatus main body 100 at the time of conveying the paper to the second post-processing apparatus 500.

Moreover, the CPU 451 reads the information pertaining to the second reverse apparatus 400 which information has been previously stored in the ROM 453 to transmit the read information to the image forming apparatus main body 100 on the basis of a control signal from the image forming apparatus main body 100. The information pertaining to the second reverse apparatus 400 is the set information peculiar to the own apparatus, such as the information pertaining to the existence of the reverse stopper in the reverse section 420, and the positional information, such as the information pertaining to the installation position (indicating what number apparatus the second reverse apparatus 400 is installed from the image forming apparatus main body 100) of the second reverse apparatus 400 in the image forming system 1.

The conveyance section 410 is the conveyance path R401 mentioned above, and conveys the paper conveyed from the first post-processing apparatus 300 to the second post-processing apparatus 500 under the control of the CPU 451. The reverse section 420 is the conveyance path R402 mentioned above, and reverses the paper conveyed from the first post-processing apparatus 300 to convey the reversed paper to the second post-processing apparatus 500 under the control of the CPU 451. The paper ejecting section 430 is the conveyance rollers 403 mentioned above to eject paper to the second post-processing apparatus 500, and ejects the paper to the second post-processing apparatus 500 under the control of the CPU 451.

The second post-processing apparatus 500 comprises a CPU 551, a RAM 552, a ROM 553, a conveyance section 510, the post-processing section 520, a paper ejecting section 530, and a communication section 580. Each section of the second post-processing apparatus 500 is connected to one another through a bus 560.

The CPU 551 performs the integrated control of each section of the second post-processing apparatus 500. The CPU 551 expands the specified program data among the various kinds of program data stored in the ROM 553 into the RAM 552, and executes various kinds of processing in cooperation with the program data expanded in the RAM 552.

To put it concretely, the CPU 551 controls the post-processing to the paper conveyed from the second reverse apparatus 400 through the first post-processing apparatus 300 on the basis of a control signal from the image forming apparatus main body 100. Moreover, the CPU 551 reads the information pertaining to the second post-processing apparatus 500 which information has been previously stored in the ROM 553 to transmit the read information to the image forming apparatus main body 100 on the basis of a control signal from the image forming apparatus main body 100.

The information pertaining to the second post-processing apparatus 500 is the set information peculiar to the own apparatus, such as the information pertaining to the assortment of the post-processing executable in the post-processing section 520 (such as stapling and punching holes) and the execution position of the post-processing to paper (such as the leading edge side/rear edge side of the paper in the conveyance direction thereof), and the positional information, such as the information pertaining to the installation position (indicating what number apparatus the second post-processing apparatus 500 is installed from the image forming apparatus main body 100) of the second post-processing apparatus 500 in the image forming system 1. Incidentally, in the present embodiment, the descriptions will be given on the supposition that the second post-processing apparatus 500 performs the post-processing to the rear edge side of paper in the conveyance direction thereof.

The conveyance section 510 are the conveyance paths R501, R502, R503, and R504 mentioned above, and conveys paper under the control of the CPU 551. The paper ejecting section 530 is the main tray 531 and the sub tray 532, mentioned above, and accumulates the paper ejected to the outside of the machine under the control of the CPU 551.

Next, the processing that is the processing to be executed under the control of the CPU 110 and that is the processing pertaining to the reverse control of the paper in the image forming system 1 will be described in detail.

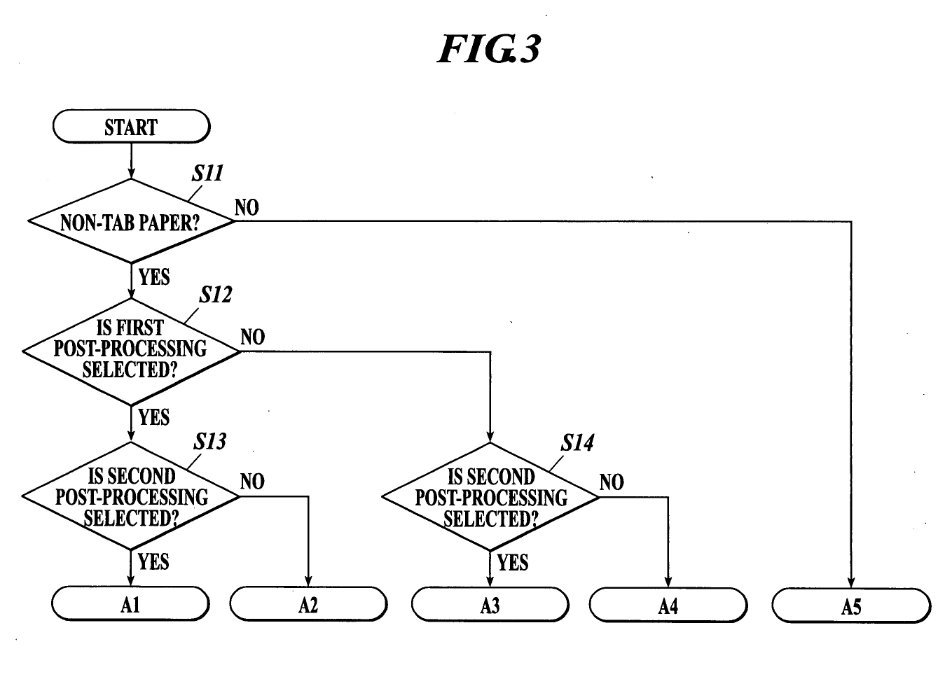

As shown in FIG. 3, when image formation is performed on a sheet of paper by the image forming section 130 and the processing is started on the basis of an instruction of the display/operation section 150, it is judged whether the paper on which the image formation has been performed on the basis of the instruction is non-tab paper (paper without the above-mentioned tab) or not (Step S11).

When it is judged that the paper is the non-tab paper by the processing at Step S11 (YES), it is judged whether the first post-processing to be executed in the first post-processing apparatus 300 and the second post-processing to be executed in the second post-processing apparatus 500 are each selected by instructions in the display/operation section 150 or not (Steps S12-S14). In the judgments at Steps S12-S14, the set information in the first post-processing apparatus 300 and the second post-processing apparatus 500 is read, and the read set information is compared with the assortment of the post-processing (such as stapling and punching holes) that is selected in the display/operation section 150 as an instruction. Thereby, the existence of selecting of the first post-processing and the second post-processing is judged.

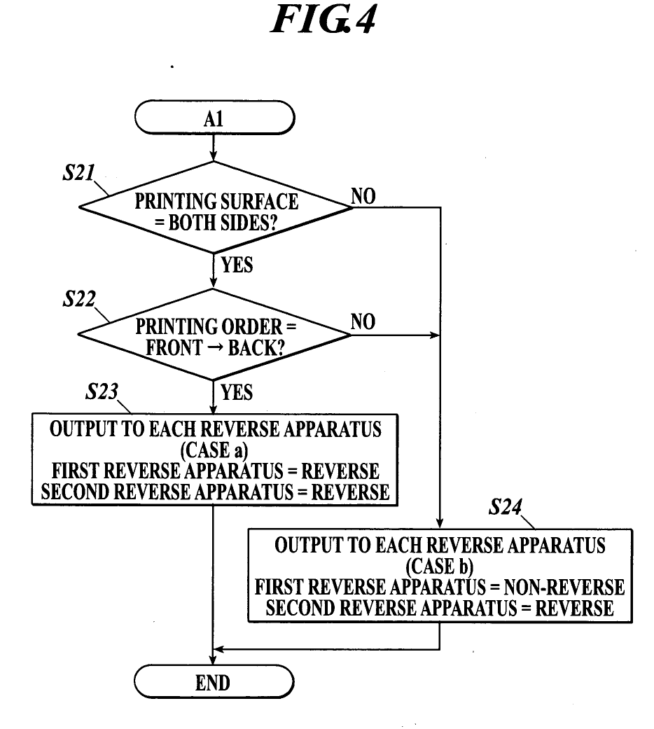

When it is judged in the judgments at Steps S12-S14 that the first and second post-processing are both selected (Step S12: YES, Step S13: YES), then it is judged whether the instruction in the display/operation section 150 indicates both side printing (image formation on both sides of a sheet of paper) or not (Step S21), as shown in FIG. 4.

Incidentally, when it is judged that the instruction indicates the both side printing in the judgment at Step S21 (Step S21: YES), then it is judged whether the printing order of the paper (the order of image formation on the paper) in the image forming section 130 has been the one from the image formation on the front surface of the paper to the image formation on the back surface thereof or not (Step S23).

When it is judged that the instruction indicates the both side printing and the printing order is the one from the front surface to the back surface (Step S21: YES, Step S22: YES) by the judgments at Steps S21 and S22 mentioned above, then control signals to perform the reverse in the first reverse apparatus 200 and the second reverse apparatus 400 are output to the first reverse apparatus 200 and the second reverse apparatus 400, respectively, in order to perform post-processing to the leading edge side of the paper in the conveyance direction thereof in the first post-processing apparatus 300, and to perform post-processing to the rear edge side of the paper in the conveyance direction thereof in the second post-processing apparatus 500 next (Step S23).

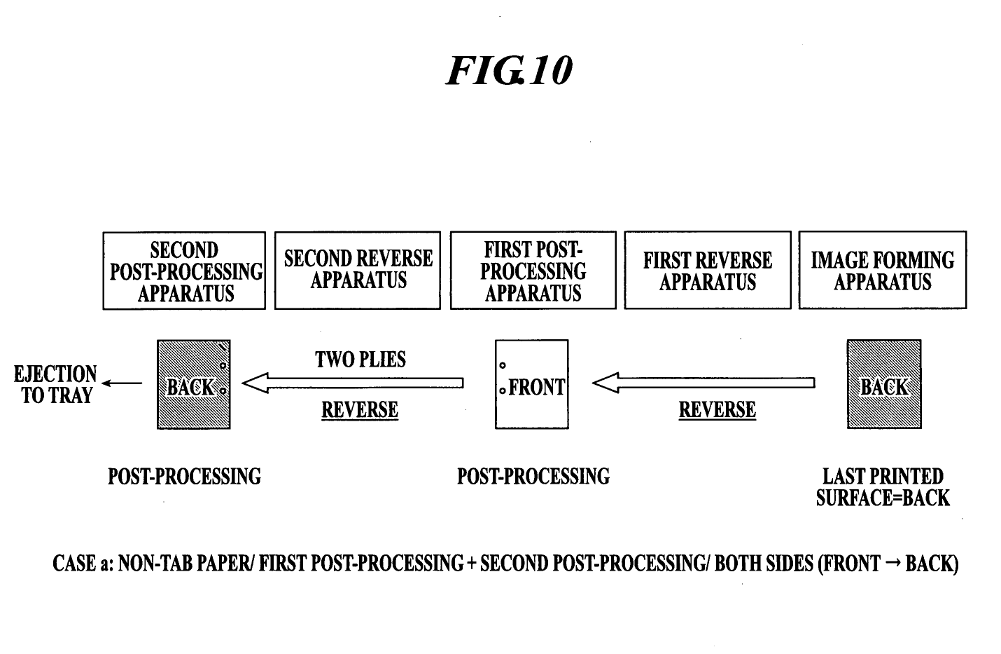

As shown in FIG. 10, in a case a to lead the processing to Step S23, the paper is a sheet of non-tab paper, and the last printed surface of the both side printing is the back surface. In this “case a”, the front of the paper ejected from the image forming apparatus main body 100 is the surface on which image formation has been performed as the back surface.

Consequently, in the “case a”, the first post-processing apparatus 300 can perform the first post-processing (for example, punching holes) on the leading edge side of a sheet of paper in the conveyance direction of the paper by reversing the paper ejected from the image forming apparatus main body 100 in the first reverse apparatus 200.

Moreover, in this “case a”, the front of the paper ejected from the first post-processing apparatus 300 is the surface on which image formation has been performed as the front surface. Consequently, in the “case a”, the second post-processing apparatus 500 can perform the second post-processing (for example, stapling) to the rear edge side of a sheet of paper in the conveyance direction of the paper by reversing the paper ejected from the first post-processing apparatus 300 in the second reverse apparatus 400.

Incidentally, the second reverse apparatus 400 may perform reverse of a sheaf of a plurality of sheets of paper (for example, two sheets) by means of the reverse stopper 421. In this case, the second post-processing apparatus 500 can perform the second post-processing to the sheaf of the sheets of paper.

As shown in FIG. 4, when it is judged that the instruction does not indicate the both side printing, or that the printing order is not the one from the front surface to the back surface though the printing is the both side printing, by the judgments at Steps S21 and S22 mentioned above (Step S21: NO/Step S21: YES and Step S22: NO), then control signals to perform no reverse in the first reverse apparatus 200 and reverse in the second reverse apparatus 400 are output to the first reverse apparatus 200 and the second reverse apparatus 400 in order to perform post-processing to the leading edge side of the paper in the conveyance direction thereof in the first post-processing apparatus 300, and to perform post-processing to the rear edge side of the paper in the conveyance direction thereof in the second post-processing apparatus 500 next (Step S24).

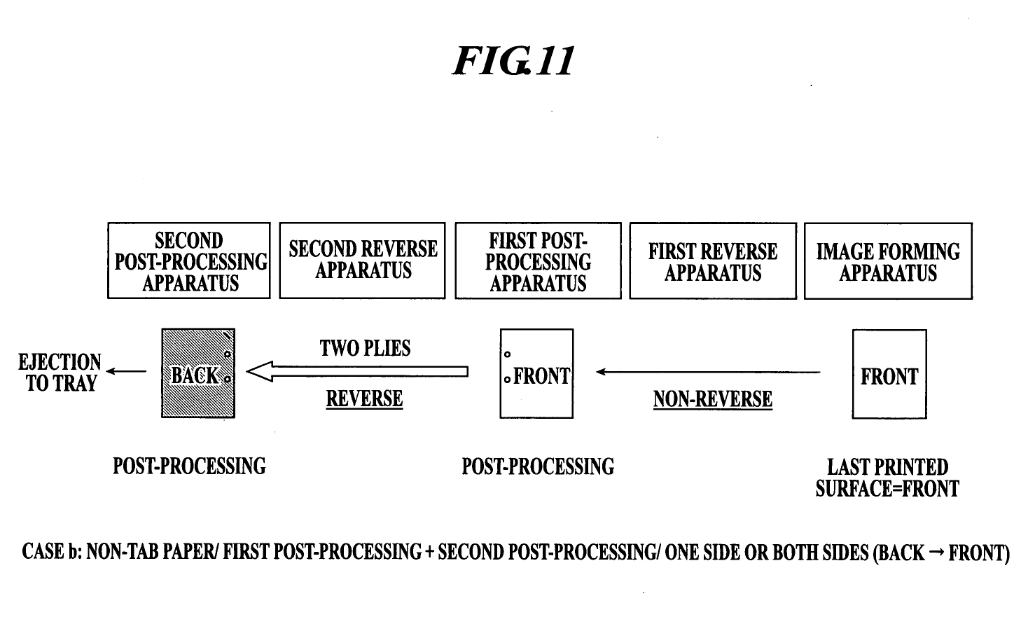

As shown in FIG. 11, in a case b to lead the processing to Step S24, the paper is a sheet of non-tab paper, and the last printed surface is the front surface. In this case b, the front of the paper ejected from the image forming apparatus main body 100 is the surface on which image formation has been performed as the front surface.

Consequently, in the case b, the first post-processing apparatus 300 can perform the first post-processing on the leading edge side of a sheet of paper in the conveyance direction of the paper by conveying the paper ejected from the image forming apparatus main body 100 without performing the reverse of the paper in the first reverse apparatus 200.

Moreover, in this case b, the front of the paper ejected from the first post-processing apparatus 300 is the surface on which image formation has been performed as the front surface. Consequently, in the case b, the second post-processing apparatus 500 can perform the second post-processing to the rear edge side of a sheet of paper in the conveyance direction of the paper by reversing the paper ejected from the first post-processing apparatus 300 in the second reverse apparatus 400.

Incidentally, the second reverse apparatus 400 may perform reverse of a sheaf of a plurality of sheets of paper (for example, two sheets) by means of the reverse stopper 421. In this case, the second post-processing apparatus 500 can perform the second post-processing to the sheaf of the sheets of paper.

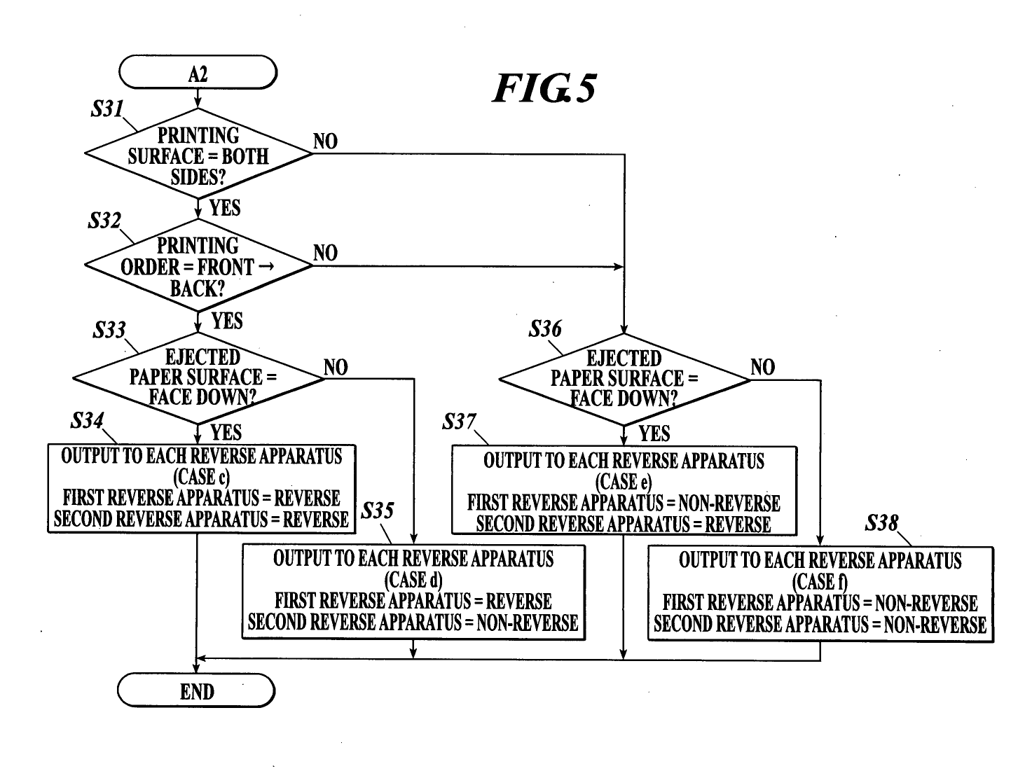

As shown in FIGS. 3 and 5, in the judgments at Steps S12-S14, when it is judged that the first post-processing is selected and the second post-processing is not selected (Step S12: YES, Step S13: NO), then the judgment whether the instruction in the display/operation section 150 indicates the both side printing or not (Step S31), the judgment whether the printing order to a sheet of paper in the image forming section 130 is the one from the front surface thereof to the back surface thereof or not (Step S32), and the judgment whether the ejected paper surface at the time of ejecting the paper to the outside of the machine is the face down or not (Steps S33 and S36) are performed.

In the judgments at Steps S31, S32, and S33 mentioned above, when it is judged that the instruction indicates the both side printing, the printing order is the one from the front surface to the back surface, and the ejected paper surface is the face down (Step S31: YES, Step S32: YES, Step S33: YES), then control signals to perform the reverse in the first reverse apparatus 200 and the second reverse apparatus 400 are output to the first reverse apparatus 200 and the second reverse apparatus 400, respectively, in order to perform post-processing to the leading edge side of the paper in the conveyance direction thereof in the first post-processing apparatus 300, and to eject the paper to the tray in the state of the face down without performing any post-processing to the paper in the second post-processing apparatus 500 next (Step S34).

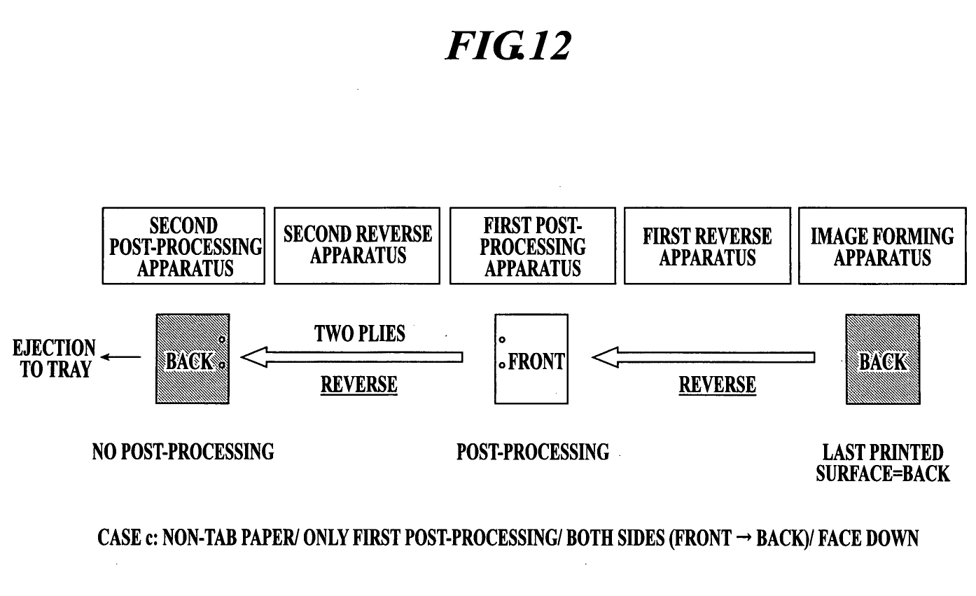

As shown in FIG. 12, in a case c to lead the processing to Step S34, the paper is a sheet of non-tab paper, and the last printed surface of the both side printing is the back surface. In this case c, the front of the paper ejected from the image forming apparatus main body 100 is the surface on which image formation has been performed as the back surface.

Consequently, in the case c, the first post-processing apparatus 300 can perform the first post-processing on the leading edge side of a sheet of paper in the conveyance direction of the paper by reversing the paper ejected from the image forming apparatus main body 100 in the first reverse apparatus 200.

Moreover, in this case c, the front of the paper ejected from the first post-processing apparatus 300 is the surface on which image formation has been performed as the front surface. Consequently, in the case c, the second post-processing apparatus 500 can eject the paper to the tray in the state of the face down by reversing the paper ejected from the first post-processing apparatus 300 in the second reverse apparatus 400.

Incidentally, the second reverse apparatus 400 may perform reverse of a sheaf of a plurality of sheets of paper (for example, two sheets) by means of the reverse stopper 421. In this case, the second post-processing apparatus 500 can eject the sheaf of the sheets of paper to the tray in the state of the face down.

As shown in FIG. 5, in the judgments at Steps S31-S33 mentioned above, when it is judged that the instruction indicates the both side printing, the printing order is the one from the front surface to the back surface, and the ejected paper surface is not the face down but the face up (Step S31: YES, Step S32: YES, Step S33: NO), then control signals to perform the reverse in the first reverse apparatus 200 and not to perform the reverse in the second reverse apparatus 400 are output to the first reverse apparatus 200 and the second reverse apparatus 400, respectively, in order to perform post-processing to the leading edge side of the paper in the conveyance direction thereof in the first post-processing apparatus 300, and to eject the paper to the tray in the state of the face up without performing any post-processing to the paper in the second post-processing apparatus 500 next (Step S35).

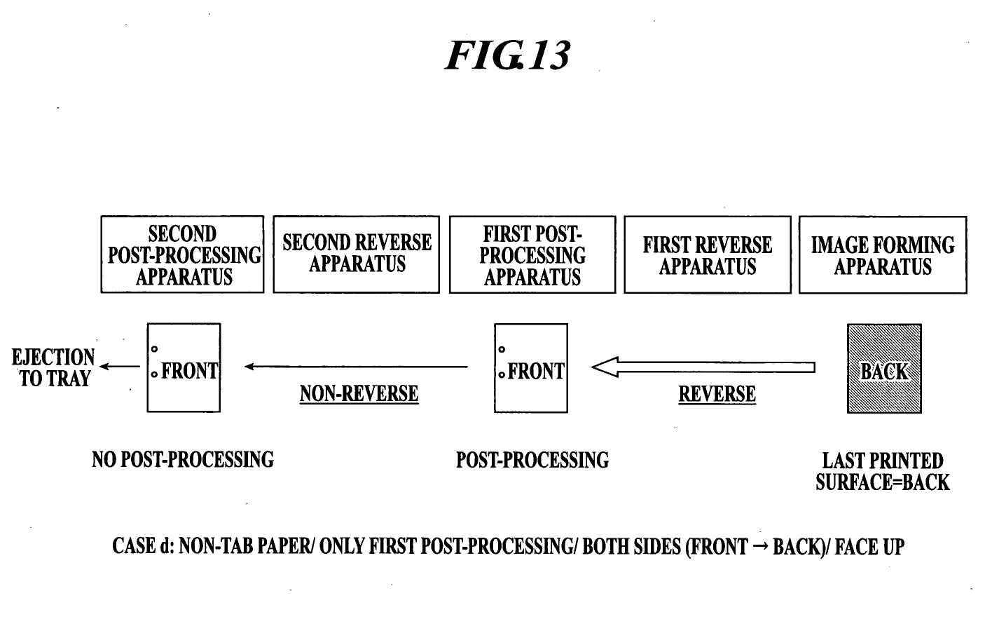

As shown in FIG. 13, in a case d to lead the processing to Step S35, the paper is a sheet of non-tab paper, and the last printed surface of the both side printing is the back surface. In this case d, the front of the paper ejected from the image forming apparatus main body 100 is the surface on which image formation has been performed as the back surface.

Consequently, in the case d, the first post-processing apparatus 300 can perform the first post-processing on the leading edge side of a sheet of paper in the conveyance direction of the paper by reversing the paper ejected from the image forming apparatus main body 100 in the first reverse apparatus 200.

Moreover, in this case d, the front of the paper ejected from the first post-processing apparatus 300 is the surface on which image formation has been performed as the front surface. Consequently, in the case d, the second post-processing apparatus 500 can eject the paper to the tray in the state of the face up by conveying the paper ejected from the first post-processing apparatus 300 without reversing the paper in the second reverse apparatus 400.

As shown in FIG. 5, in the judgments at Steps S31, S32, and S36 mentioned above, when it is judged that the instruction does not indicate the both side printing and the ejected paper surface is the face down (Step S31: NO, Step S36: YES), or when it is judged that the instruction indicates the both side printing, but the printing order is not the one from the front surface to the back surface, and the ejected paper surface is the face down (Step S31: YES, Step S32: NO, Step S36: YES), then control signals not to perform the reverse in the first reverse apparatus 200 and to perform the reverse in the second reverse apparatus 400 are output to the first reverse apparatus 200 and the second reverse apparatus 400, respectively, in order to perform post-processing to the leading edge side of the paper in the conveyance direction thereof in the first post-processing apparatus 300, and to eject the paper to the tray in the state of the face down without performing any post-processing to the paper in the second post-processing apparatus 500 next (Step S37).

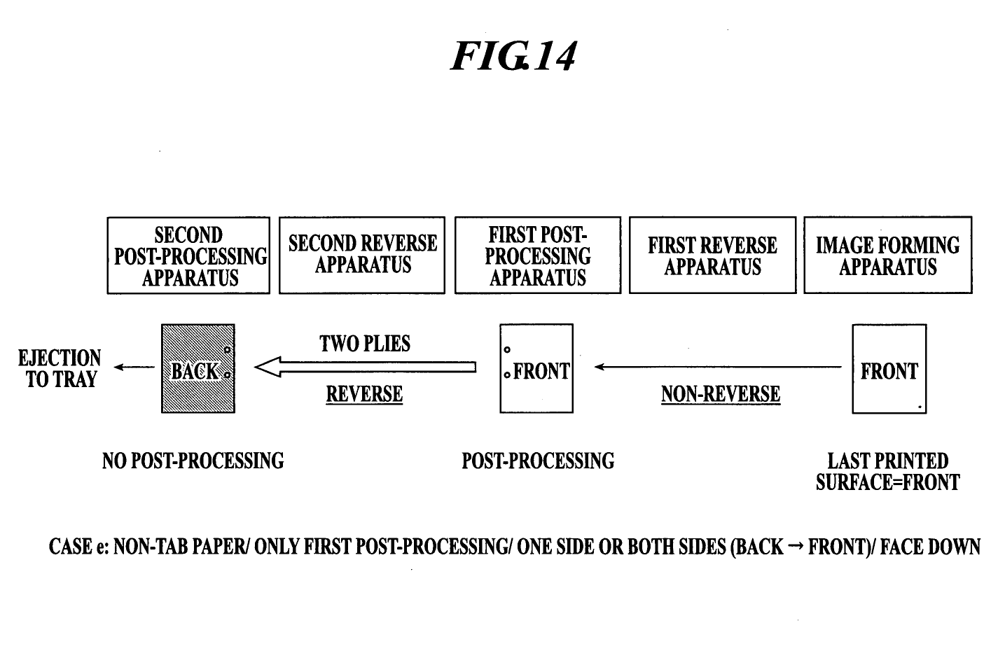

As shown in FIG. 14, in a case e to lead the processing to Step S37, the paper is a sheet of non-tab paper, and the last printed surface is the front surface. In this case e, the surface of the paper ejected from the image forming apparatus main body 100 is the surface on which image formation has been performed as the front surface.

Consequently, in the case e, the first post-processing apparatus 300 can perform the first post-processing on the leading edge side of a sheet of paper in the conveyance direction of the paper by conveying the paper ejected from the image forming apparatus main body 100 without reversing the paper in the first reverse apparatus 200.

Moreover, in this case e, the front of the paper ejected from the first post-processing apparatus 300 is the surface on which image formation has been performed as the front surface. Consequently, in the case e, the second post-processing apparatus 500 can eject the paper to the tray in the state of the face down by reversing the paper ejected from the first post-processing apparatus 300 in the second reverse apparatus 400.

Incidentally, the second reverse apparatus 400 may perform reverse of a sheaf of a plurality of sheets of paper (for example, two sheets) by means of the reverse stopper 421. In this case, the second post-processing apparatus 500 can eject the sheaf of the sheets of paper to the tray in the state of the face down.

As shown in FIG. 5, in the judgments at Steps S31, S32, and S36 mentioned above, when it is judged that the instruction does not indicate the both side printing and the ejected paper surface is the face up (Step S31: NO, Step S36: NO), or when it is judged that the instruction indicates the both side printing, but the printing order is not the one from the front surface to the back surface, and the ejected paper surface is the face up (Step S31: YES, Step S32: NO, Step S36: NO), then control signals not to perform the reverse in the first reverse apparatus 200 and the second reverse apparatus 400 are output to the first reverse apparatus 200 and the second reverse apparatus 400, respectively, in order to perform post-processing to the leading edge side of the paper in the conveyance direction thereof in the first post-processing apparatus 300, and to eject the paper to the tray in the state of the face up without performing any post-processing to the paper in the second post-processing apparatus 500 next (Step S38).

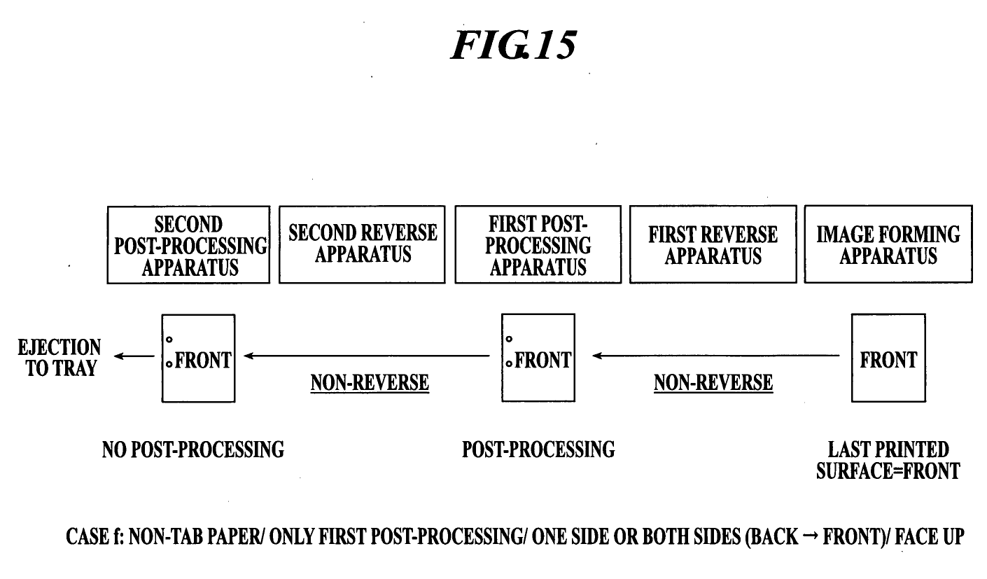

As shown in FIG. 15, in a case f to lead the processing to Step S38, the paper is a sheet of non-tab paper, and the last printed surface is the front surface. In this case f, the surface of the paper ejected from the image forming apparatus main body 100 is the surface on which image formation has been performed as the front surface.

Consequently, in the case f, the first post-processing apparatus 300 can perform the first post-processing on the leading edge side of a sheet of paper in the conveyance direction of the paper by conveying the paper ejected from the image forming apparatus main body 100 without reversing the paper in the first reverse apparatus 200.

Moreover, in this case f, the front of the paper ejected from the first post-processing apparatus 300 is the surface on which image formation has been performed as the front surface. Consequently, in the case f, the second post-processing apparatus 500 can eject the paper to the tray in the state of the face up by conveying the paper ejected from the first post-processing apparatus 300 without reversing the paper in the second reverse apparatus 400.

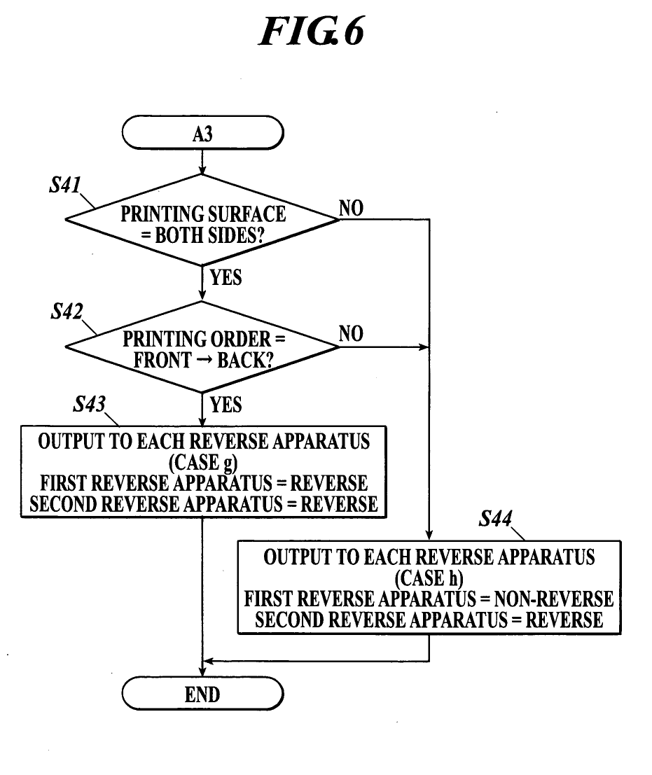

As shown in FIGS. 3 and 6, in the judgments at Steps S12-S14, when it is judged that the first post-processing is not selected and the second post-processing is selected (Step S12: NO, Step S14: YES), then the judgment whether the instruction in the display/operation section 150 indicates the both side printing or not (Step S41) and the judgment whether the printing order to a sheet of paper in the image forming section 130 is the one from the front surface thereof to the back surface thereof or not (Step S42) is performed.

In the judgments at Steps S41 and S42 mentioned above, when it is judged that the instruction indicates the both side printing and the printing order is the one from the front surface to the back surface (Step S41: YES, Step S42: YES), then control signals to perform the reverse in the first reverse apparatus 200 and the second reverse apparatus 400 are output to the first reverse apparatus 200 and the second reverse apparatus 400, respectively, in order not to perform any post-processing in the first post-processing apparatus 300, and in order to perform post-processing to the rear edge side of the paper in the conveyance direction thereof in the second post-processing apparatus 500 next (Step S43).

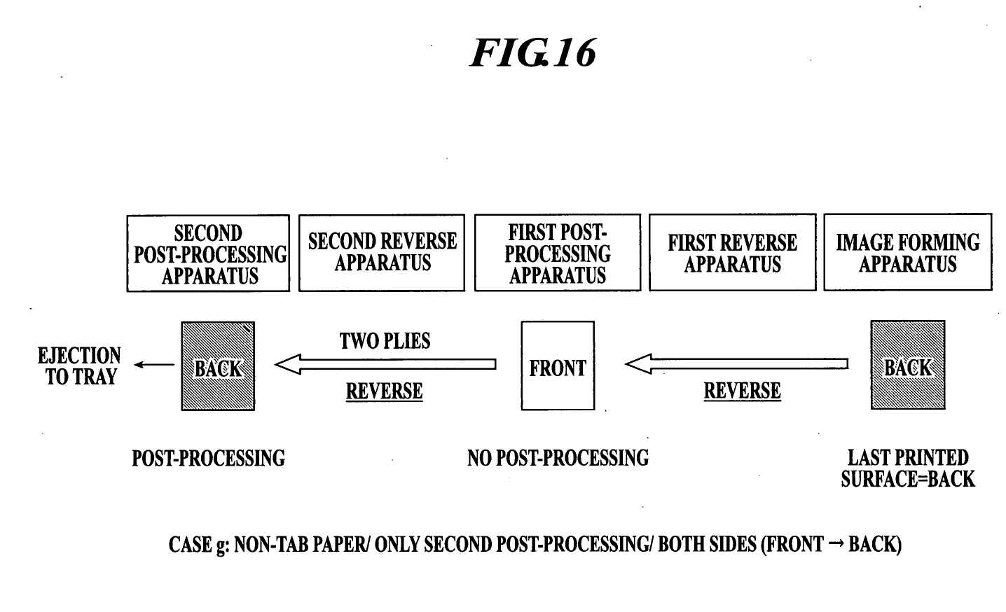

As shown in FIG. 16, in a case g to lead the processing to Step S43, the paper is a sheet of non-tab paper, and the last printed surface of the both side printing is the back surface. In this case g, the front of the paper ejected from the image forming apparatus main body 100 is the surface on which image formation has been performed as the back surface.

Consequently, in the case g, the second post-processing apparatus 500 can perform the second post-processing on the rear edge side of a sheet of paper in the conveyance direction of the paper by reversing the paper ejected from the image forming apparatus main body 100 in the first reverse apparatus 200 and the second reverse apparatus 400 sequentially.

Moreover, in this case g, because the front of the conveyed paper becomes the surface on which image formation has been performed as the front surface by reversing the paper in the first reverse apparatus 200, even when the second reverse apparatus 400 has performed the reverse of a sheaf of a plurality of sheets of paper, the sheets of paper do not become in a reverse order. Consequently, the second post-processing apparatus 500 can perform the second post-processing to a sheaf of sheets of paper that has been bundled in the order of image formation.

As shown in FIG. 6, in the judgments at Steps S41 and S42 mentioned above, when the instruction does not indicate the both side printing (Step S41: NO), or when the instruction indicates the both side printing but the printing order is not the one from the front surface to the back surface (Step S41: YES, Step S42: NO), then control signals to perform no reverse in the first reverse apparatus 200 and to perform reverse in the second reverse apparatus 400 are output to the first reverse apparatus 200 and the second reverse apparatus 400, respectively, in order not to perform any post-processing in the first post-processing apparatus 300 and in order to perform the post-processing to the rear edge side of the paper in the conveyance direction thereof in the second post-processing apparatus 500 next (Step S44).

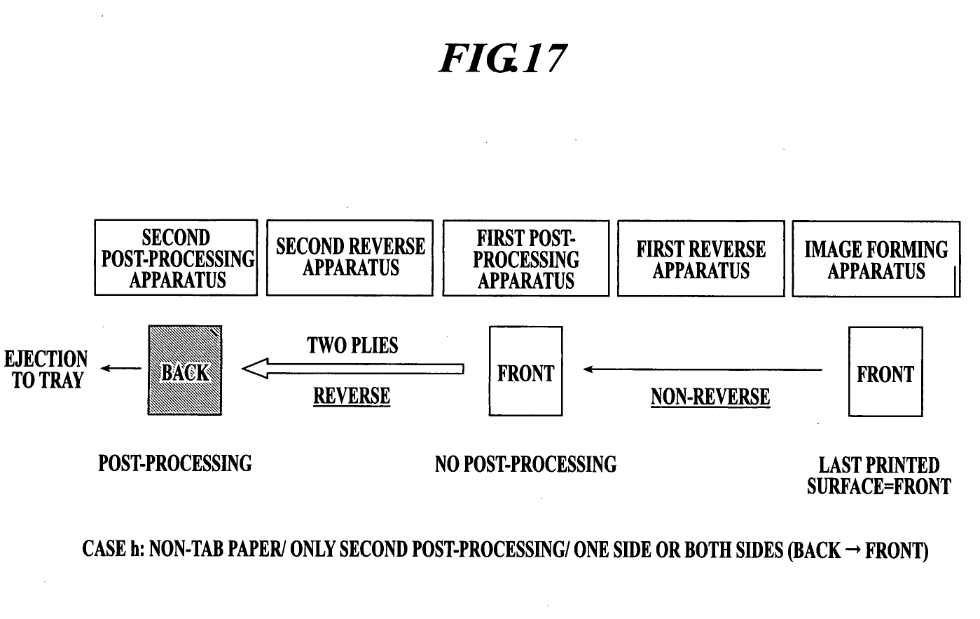

As shown in FIG. 17, in a case h to lead the processing to Step S44, the paper is a sheet of non-tab paper, and the last printed surface is the front surface. In this case h, the front of the paper ejected from the image forming apparatus main body 100 is the surface on which image formation has been performed as the front surface.

Consequently, in the case h, the second post-processing apparatus 500 can perform the second post-processing on the rear edge side of a sheet of paper ejected from the image forming apparatus main body 100 in the conveyance direction of the paper by not performing any reverse of the paper in the first reverse apparatus 200 and by performing reverse of the paper in the second reverse apparatus 400.

Moreover, in this case h, because the first reverse apparatus 200 does not perform any reverse and the second reverse apparatus 400 performs reverse, it is possible to reverse a sheaf of a plurality of sheets of paper bundled in the order of image formation by the image forming apparatus main body 100. Consequently, the second post-processing apparatus 500 can perform the second post-processing to the sheaf of sheets of paper bundled in the order of the image formation.

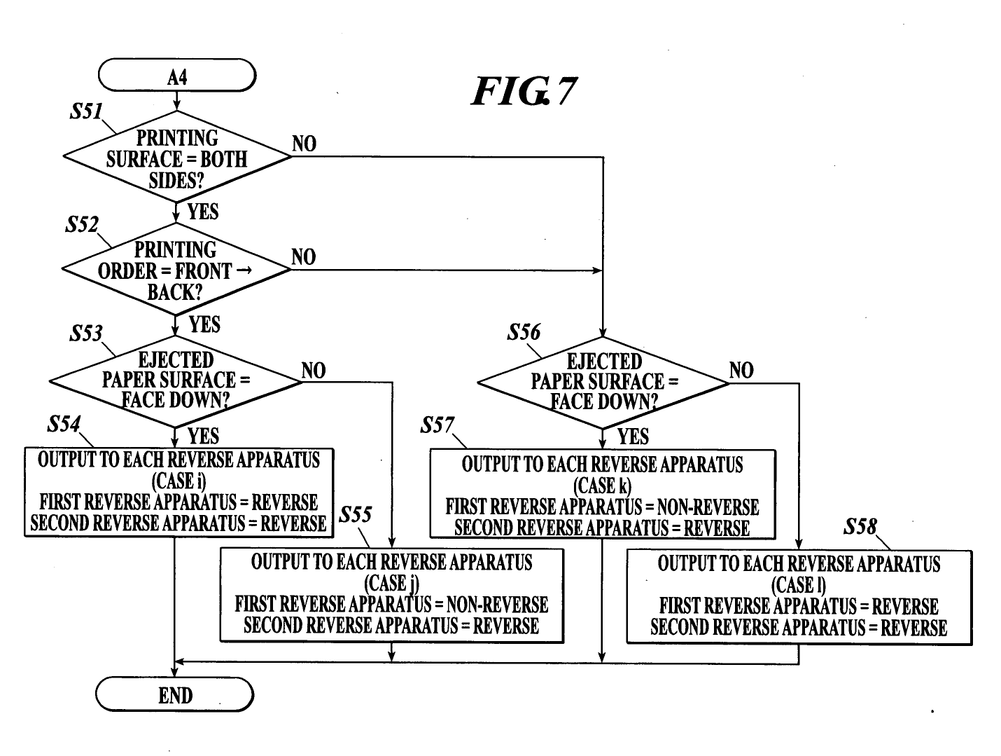

As shown in FIGS. 3 and 7, in the judgments at Steps S12-S14, when it is judged that the first and second post-processing are not selected (Step S12: NO, Step S14: NO), then the judgment whether the instruction in the display/operation section 150 indicates the both side printing or not (Step S51), the judgment whether the printing order to a sheet of paper in the image forming section 130 is the one from the front surface thereof to the back surface thereof or not (Step S52), and the judgment whether the ejected paper surface at the time of ejecting the paper to the outside of the machine is the face down or not (Steps S53 and S56) are performed.

In the judgments at Steps S51-S53 mentioned above, when it is judged that the instruction indicates the both side printing, the printing order is the one from the front surface to the back surface, and the ejected paper surface is face down (Step S51: YES, Step S52: YES, Step S53: YES), then control signals to perform the reverse in the first reverse apparatus 200 and the second reverse apparatus 400 are output to the first reverse apparatus 200 and the second reverse apparatus 400, respectively, in order not to perform any post-processing in the first post-processing apparatus 300 and the second post-processing apparatus 500, and in order to eject the paper to the tray in the state of the face down (Step S54).

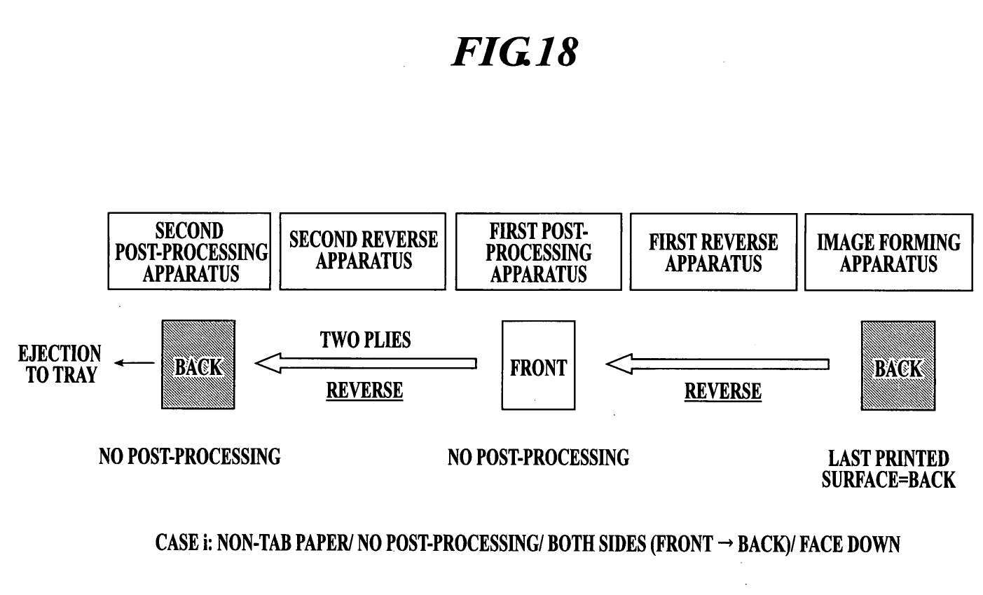

As shown in FIG. 18, in a case i to lead the processing to Step S54, the paper is a sheet of non-tab paper, and the last printed surface of the both side printing is the back surface. In this case i, the front of the paper ejected from the image forming apparatus main body 100 is the surface on which image formation has been performed as the back surface.

Consequently, in the case i, the second post-processing apparatus 500 can eject the paper ejected from the image forming apparatus main body 100 to the tray in the state of the face down of the paper without performing the first and second post-processing to the paper by reversing the paper in the first reverse apparatus 200 and the second reverse apparatus 400 sequentially.

Moreover, in the case i, because the front of the conveyed paper becomes the surface on which image formation has been performed as the front surface by reversing the paper in the first reverse apparatus 200, even when the second reverse apparatus 400 has performed the reverse of a sheaf of a plurality of sheets of paper, the stack order of the sheets of paper does not become in a reverse order. Consequently, the second post-processing apparatus 500 can eject the sheaf of the sheets of paper bundled in the order of image formation to the tray in the state of the face down.

As shown in FIG. 7, in the judgments at Steps S51-S53 mentioned above, when it is judged that the instruction indicates the both side printing, the printing order is the one from the front surface to the back surface, and the ejected paper surface is the face up (Step S51: YES, Step S52: YES, Step S53: NO), then control signals to perform no reverse in the first reverse apparatus 200 and to perform reverse in the second reverse apparatus 400 are output to the first reverse apparatus 200 and the second reverse apparatus 400, respectively, in order to eject a sheet of paper to the tray in the state of the face up without performing any post-processing in the first post-processing apparatus 300 and the second post-processing apparatus 500 (Step S55).

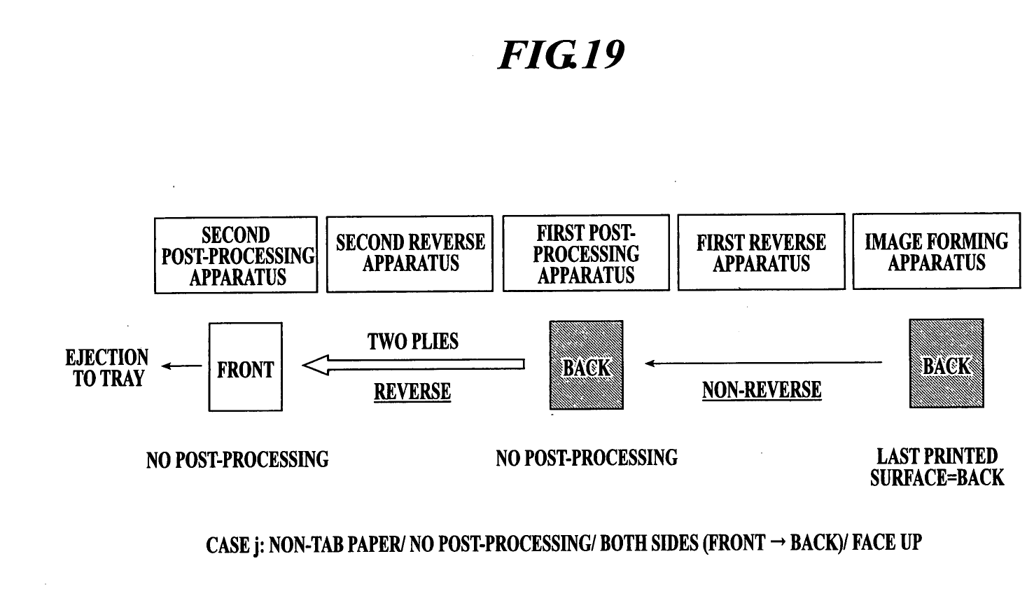

As shown in FIG. 19, in a case j to lead the processing to Step S55, the paper is a sheet of non-tab paper, and the last printed surface of the both side printing is the back surface. In this case j, the front of the paper ejected from the image forming apparatus main body 100 is the surface on which image formation has been performed as the back surface.

Consequently, in the case j, the second post-processing apparatus 500 can eject a sheet of paper ejected from the image forming apparatus main body 100 to the tray in the state of the face up without performing the first and second post-processing to the paper by performing no reverse of the paper in the first reverse apparatus 200 and by performing the reverse of the paper in the second reverse apparatus 400.

Moreover, in the case j, because the first reverse apparatus 200 does not perform any reverse of the paper and the second reverse apparatus 400 performs the reverse of the paper, it is possible to reverse a sheaf of a plurality of sheets of paper bundled in the order of image formation by the image forming apparatus main body 100. Consequently, the second post-processing apparatus 500 can eject the sheaf of the sheets of paper bundled in the order of the image formation to the tray in the state of the face up.

As shown in FIG. 7, in the judgments at Steps S51, S52, and S56 mentioned above, when it is judged that the instruction indicates no both side printing and the ejected paper surface is the face down (Step S51: NO, Step S56: YES), or when it is judged that the instruction indicates the both side printing, but the printing order is not the one from the front surface to the back surface, and the ejected paper surface is the face down (Step S51: YES, Step S52: NO, Step S56: YES), then control signals to perform no reverse in the first reverse apparatus 200 and to perform reverse in the second reverse apparatus 400 are output to the first reverse apparatus 200 and the second reverse apparatus 400, respectively, in order to eject a sheet of paper to the tray in the state of the face down without performing any post-processing in the first post-processing apparatus 300 and the second post-processing apparatus 500 (Step S57).

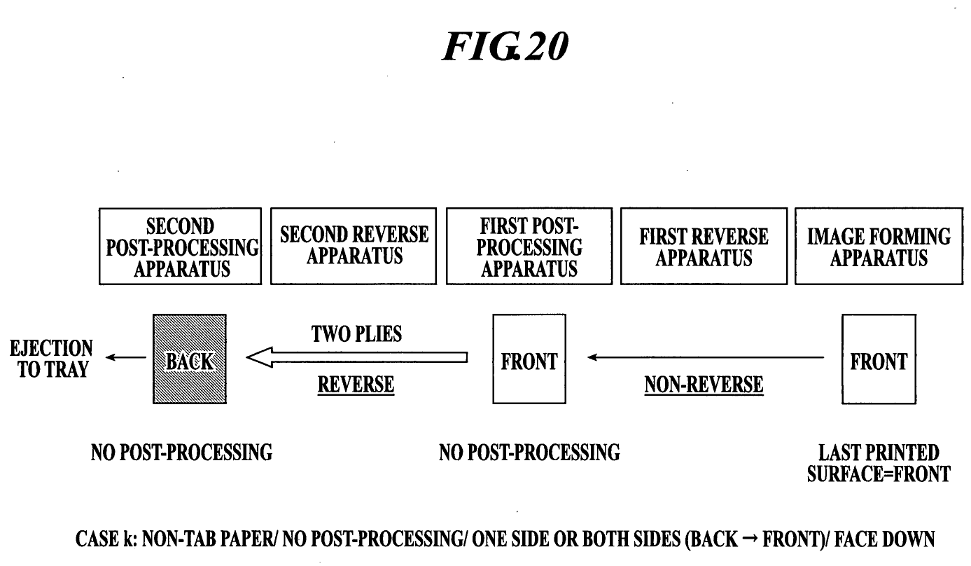

As shown in FIG. 20, in a case k to lead the processing to Step S57, the paper is a sheet of non-tab paper, and the last printed surface is the front surface. In this case k, the surface of the paper ejected from the image forming apparatus main body 100 is the surface on which image formation has been performed as the front surface.

Consequently, in the case k, the second post-processing apparatus 500 can eject a sheet of paper ejected from the image forming apparatus main body 100 to the tray in the state of the face down without performing the first and second post-processing to the paper by performing no reverse of the paper in the first reverse apparatus 200 and by performing the reverse of the paper in the second reverse apparatus 400.

Moreover, in the case k, because the first reverse apparatus 200 does not perform any reverse of the paper and the second reverse apparatus 400 performs the reverse of the paper, it is possible to reverse a sheaf of a plurality of sheets of paper bundled in the order of image formation by the image forming apparatus main body 100. Consequently, the second post-processing apparatus 500 can eject the sheaf of the sheets of paper bundled in the order of the image formation to the tray in the state of the face down.

As shown in FIG. 7, in the judgments at Steps S51, S52, and S56 mentioned above, when it is judged that the instruction indicates no both side printing and the ejected paper surface is the face up (Step S51: NO, Step S56: NO), or when it is judged that the instruction indicates the both side printing, but the printing order is not the one from the front surface to the back surface, and the ejected paper surface is the face up (Step S51: YES, Step S52: NO, Step S56: NO), then control signals to perform the reverse of a sheet of paper in the first reverse apparatus 200 and the second reverse apparatus 400 are output to the first reverse apparatus 200 and the second reverse apparatus 400, respectively, in order to eject the paper to the tray in the state of the face up without performing any post-processing in the first post-processing apparatus 300 and the second post-processing apparatus 500 (Step S58).

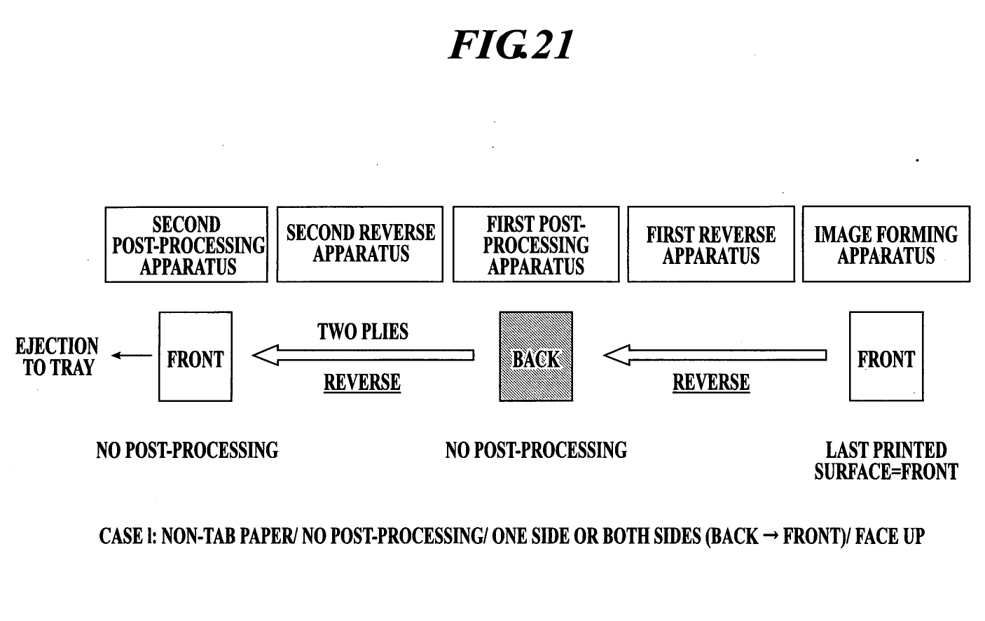

As shown in FIG. 21, in a case 1 to lead the processing to Step S58, the paper is a sheet of non-tab paper, and the last printed surface is the front surface. In this case 1, the surface of the paper ejected from the image forming apparatus main body 100 is the surface on which image formation has been performed as the front surface.

Consequently, in the case 1, the second post-processing apparatus 500 can eject a sheet of paper ejected from the image forming apparatus main body 100 to the tray in the state of the face up without performing the first and second post-processing to the paper by reversing the paper in the first reverse apparatus 200 and the second reverse apparatus 400 sequentially.

Moreover, in the case 1, because the front of the conveyed paper is the surface on which image formation has been performed as the front surface by the reverse of the paper by the first reverse apparatus 200, even when the second reverse apparatus 400 has performed the reverse of a sheaf of a plurality of sheets of paper, the stack order of the sheets of paper does not become the reverse order thereof. Consequently, the second post-processing apparatus 500 can eject the sheaf of the sheets of paper bundled in the order of the image formation to the tray in the state of the face down.

As shown in FIGS. 3, 8 and 9, when it is judged that a sheet of paper is tab paper at Step S11 (NO), then the judgment whether an instruction in the display/operation section 150 indicates the both side printing or not (Step S61), the judgment whether the printing order of a sheet of paper in the image forming section 130 is the one from the front surface thereof to the back surface thereof or not (Step S62), and the judgment whether the ejected paper surface at the time of ejecting the paper to the outside of the machine is the face down or not (Steps S63 and S70) are performed.

Incidentally, in the judgments at Steps S61, S62, and S63, when it is judged that the instruction indicates the both side printing, the printing order is the one from the front surface to the back surface, the ejected paper surface is the face up (Step S61: YES, Step S62: YES, Step S63: NO), then the judgment whether there is leading edge striking to the reverse stopper owing to the tab of a sheet of paper in each reverse apparatus or not, that is, the judgment whether the reverse stopper is installed or not, is performed on the basis of the set information of each reverse apparatus (Steps S65 and S67).

In the judgments at Steps S61-S63 mentioned above, when it is judged that the instruction indicates the both side printing, the printing order is the one from the front surface to the back surface, and the ejected paper surface is face down (Step S61: YES, Step S62: YES, Step S63: YES), then control signals not to perform the reverse of a sheet of paper in the first reverse apparatus 200 and the second reverse apparatus 400 are output to the first reverse apparatus 200 and the second reverse apparatus 400, respectively, in order to eject the tab paper to the tray in the state of the face down in the second post-processing apparatus 500 (Step S64).

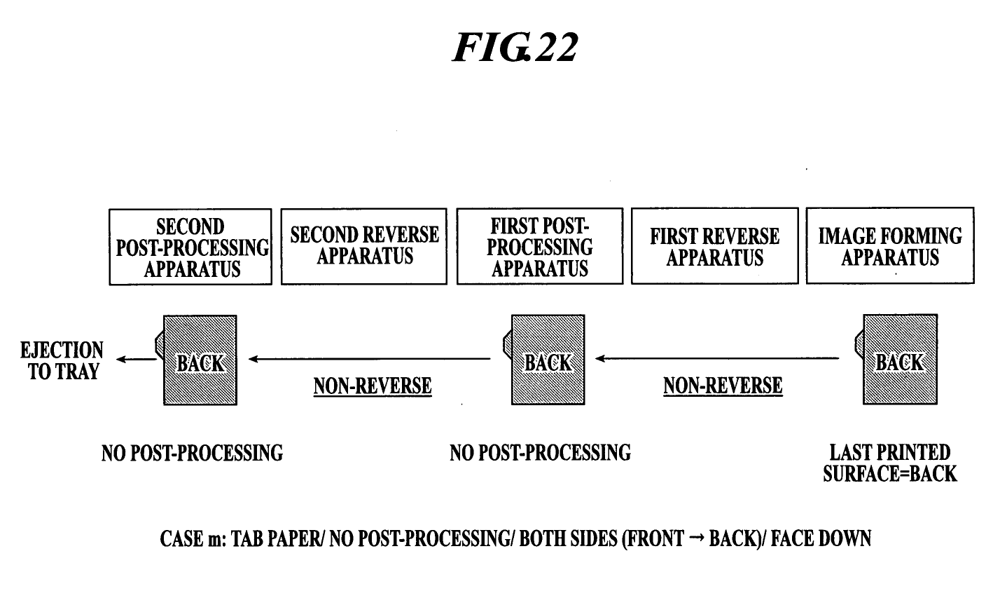

As shown in FIG. 22, in a case m to lead the processing to Step S64, the paper is a sheet of tab paper, and the last printed surface of the both side printing is the back surface. In this case m, the front of the paper ejected from the image forming apparatus main body 100 is the surface on which image formation has been performed as the back surface.

Consequently, in the case m, the second post-processing apparatus 500 can eject the paper ejected from the image forming apparatus main body 100 to the tray in the state of the face down of the paper by conveying the paper without performing the reverse of the paper in the first reverse apparatus 200 and the second reverse apparatus 400.

Moreover, in the case m, the paper ejected from the image forming apparatus main body 100 is the tab paper. The end of the tab of the paper sometimes collides with the reverse stopper in the reverse mechanism of each reverse apparatus. However, in the case m, because the conveyed paper is not reversed, there is no possibility that any conveyance failures, such as the collision of the end of the tab, occur.

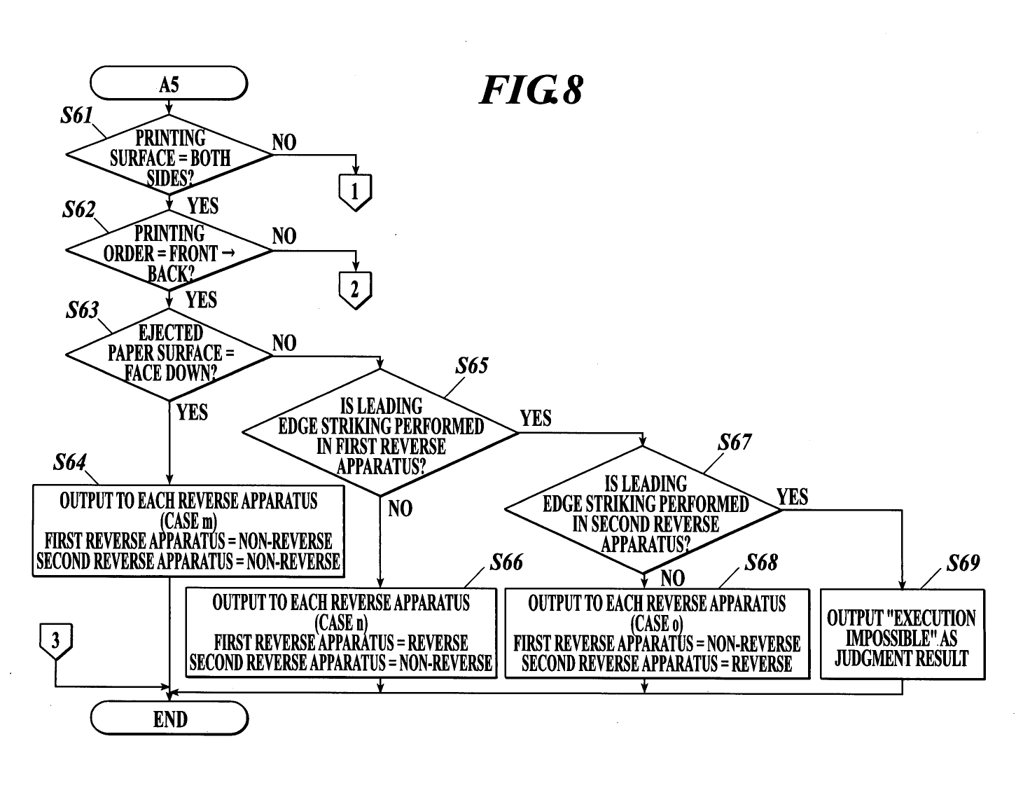

As shown in FIG. 8, in the judgments at Steps S61-S63 and S65 mentioned above, when it is judged that the instruction indicates the both side printing, the printing order is the one from the front surface to the back surface, the ejected paper surface is the face up, and there is no leading edge striking of a tab in the first reverse apparatus 200 (Step S61: YES, Step S62: YES, Step S63: NO, Step S65: NO), then control signals to perform the reverse of the paper in the first reverse apparatus 200 and to perform no reverse of the paper in the second reverse apparatus 400 are output to the first reverse apparatus 200 and the second reverse apparatus 400, respectively, (Step S66).

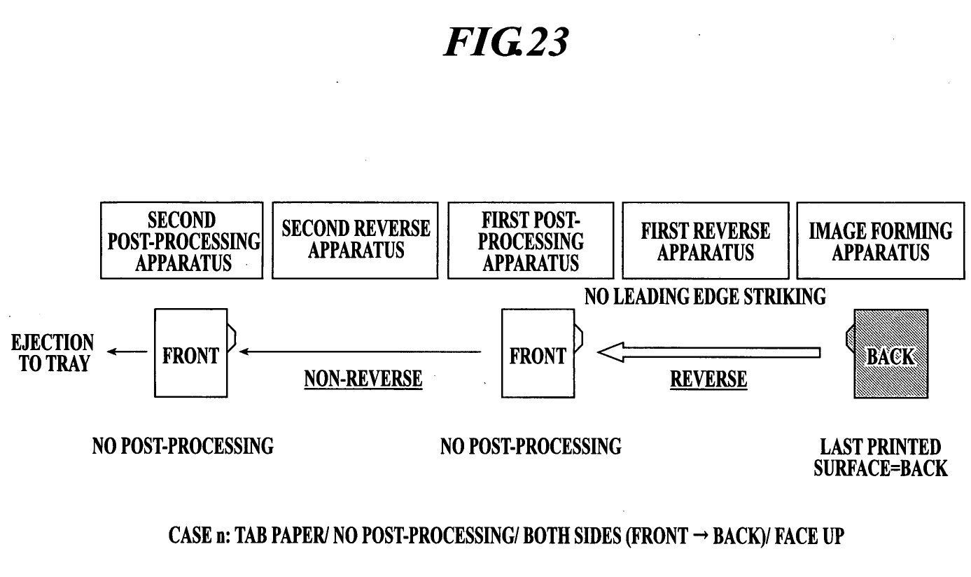

As shown in FIG. 23, in a case n to lead the processing to Step S66, the paper is a sheet of tab paper, and the last printed surface of the both side printing is the back surface. In this case n, the front of the paper ejected from the image forming apparatus main body 100 is the surface on which image formation has been performed as the back surface.

Consequently, in the case n, the second post-processing apparatus 500 can eject a sheet of paper ejected from the image forming apparatus main body 100 to the tray in the state of the face up by performing the reverse of the paper in the first reverse apparatus 200 and by performing no reverse of the paper in the second reverse apparatus 400.

Moreover, in the case n, although the paper ejected from the image forming apparatus main body 100 is the tab paper, the first reverse apparatus 200, which is not provided with any reverse stopper, performs the reverse of the paper. Consequently, there is no chance of the collision of the end of the tab to the reverse stopper.

As shown in FIG. 8, in the judgments at Steps S61-S63, S65, and S67 mentioned above, when it is judged that the instruction indicates the both side printing, the printing order is the one from the front surface to the back surface, the ejected paper surface is the face up, there is leading edge striking of the tab in the first reverse apparatus 200, and there is no leading edge striking of the tab in the second reverse apparatus 400 (Step S61: YES, Step S62: YES, Step S63: NO, Step S65: YES, Step S67: NO), then control signals to perform no reverse of the paper in the first reverse apparatus 200 and to perform the reverse of the paper in the second reverse apparatus 400 are output to the first reverse apparatus 200 and the second reverse apparatus 400, respectively (Step S68).

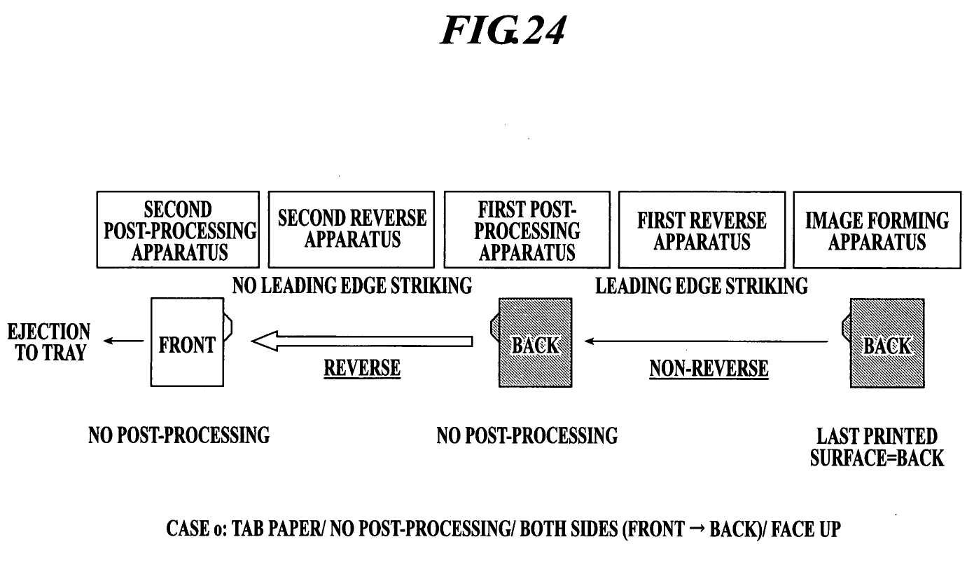

As shown in FIG. 24, in a case o to lead the processing to Step S68, the paper is a sheet of tab paper, and the last printed surface of the both side printing is the back surface. In this case o, the front of the paper ejected from the image forming apparatus main body 100 is the surface on which image formation has been performed as the back surface.

Consequently, in the case o, the second post-processing apparatus 500 can eject a sheet of paper ejected from the image forming apparatus main body 100 to the tray in the state of the face up by performing no reverse of the paper in the first reverse apparatus 200 and by performing the reverse of the paper in the second reverse apparatus 400.

Moreover, in the case o, although the paper ejected from the image forming apparatus main body 100 is the tab paper, the paper is not reversed in the first reverse apparatus 200 which is provided with the reverse stopper, but is reversed in the second reverse apparatus 400 which is not provided with any reverse stoppers. Consequently, there is no chance of the colliding of the end of the tab with the reverse stopper.

As shown in FIG. 8, in the judgments at Steps S61-S63, S65, and S67 mentioned above, when it is judged that the instruction indicates the both side printing, the printing order is the one from the front surface to the back surface, the ejected paper surface is the face up, the leading edge striking of a tab is performed in the first reverse apparatus 200, and the leading edge striking of a tab is performed in the second reverse apparatus 400 (Step S61: YES, Step S62: YES, Step S63: NO, Step S65: YES, Step S67: YES), then an error signal indicating the impossibility of execution is output (Step S69). To put it concretely, as an error output, a control signal is output so that a sheet of paper is conveyed without being reversed in the first reverse apparatus 200 and the second reverse apparatus 400, and is ejected from the sub tray 331 or the sub tray 532.

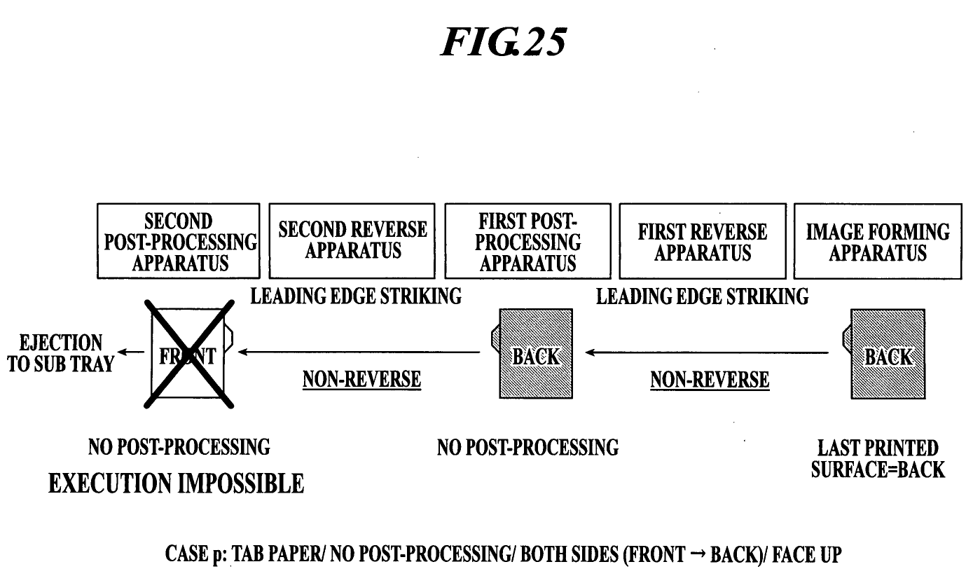

As shown in FIG. 25, in a case p to lead the processing to Step S69, the paper is a sheet of tab paper, and the last printed surface of the both side printing is the back surface. In this case p, the front of the paper ejected from the image forming apparatus main body 100 is the surface on which image formation has been performed as the back surface.

Consequently, in the case p, the reverse to eject a sheet of paper from the second post-processing apparatus 500 to the tray in the state of the face up is not performed in the first reverse apparatus 200 and the second reverse apparatus 400, in both of which the leading edge striking of a tab is performed, and the paper is ejected to the sub tray as an error. In the case p, because the reverse of a sheet of tab paper is not performed in the first reverse apparatus 200 and the second reverse apparatus 400, in both of which the leading edge striking of a tab is performed, the conveyance failure caused by the collision of the leading edge of the tab with the reverse stopper can be previously prevented.

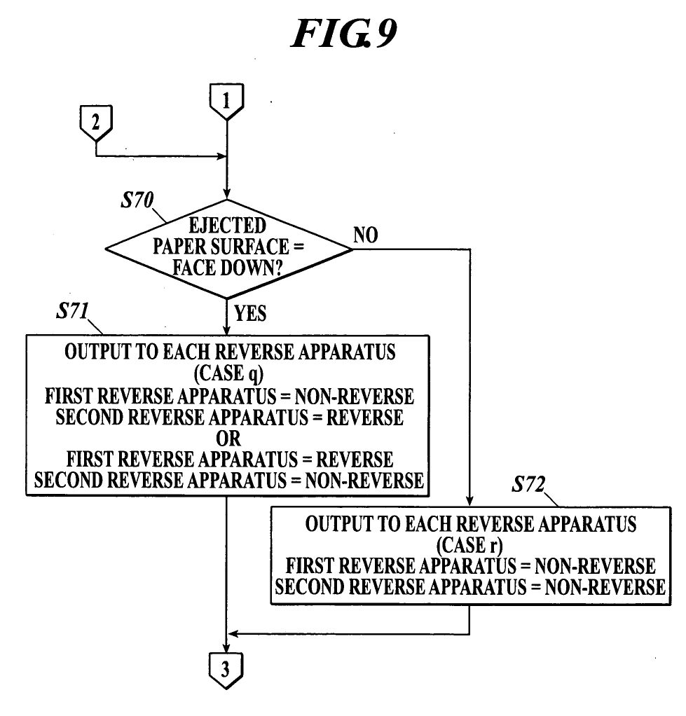

As shown in FIGS. 8 and 9, in the judgments at Steps S61, S62, and S70 mentioned above, when it is judged that the instruction does not indicates the both side printing and the ejected paper surface is the face down (Step S61: NO, Step S70: YES), or when it is judged that the instruction indicates the both side printing, but the printing order is not the one from the front surface to the back surface, and the ejected paper surface is the face down (Step S61: YES, Step S62: NO, Step S70: YES), then control signals to perform no reverse of the paper in the first reverse apparatus 200 and to perform the reverse of the paper in the second reverse apparatus 400, or control signals to perform the reverse of the paper in the first reverse apparatus 200 and to perform no reverse of the paper in the second reverse apparatus 400 are output to the first reverse apparatus 200 and the second reverse apparatus 400, respectively (Step S71).

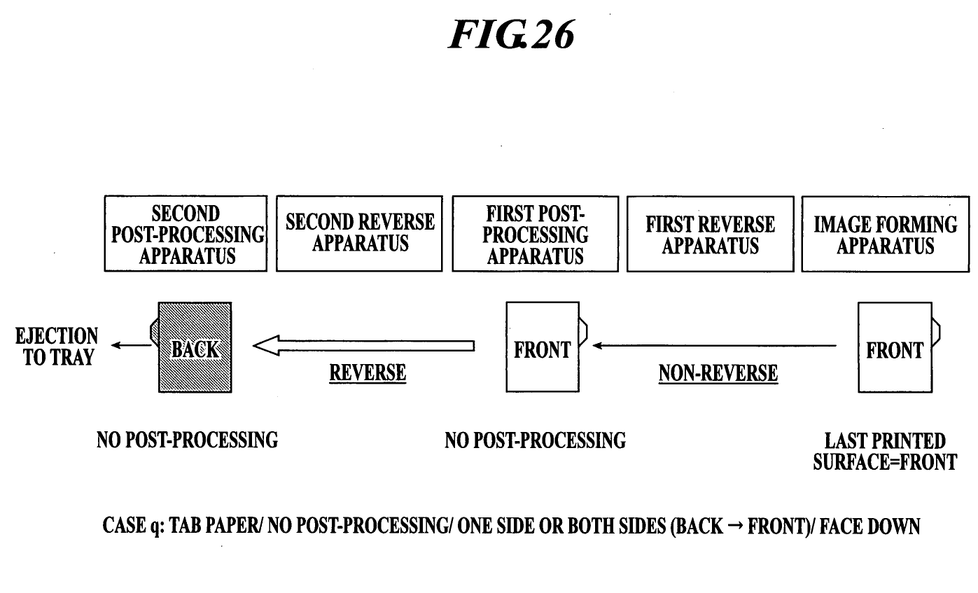

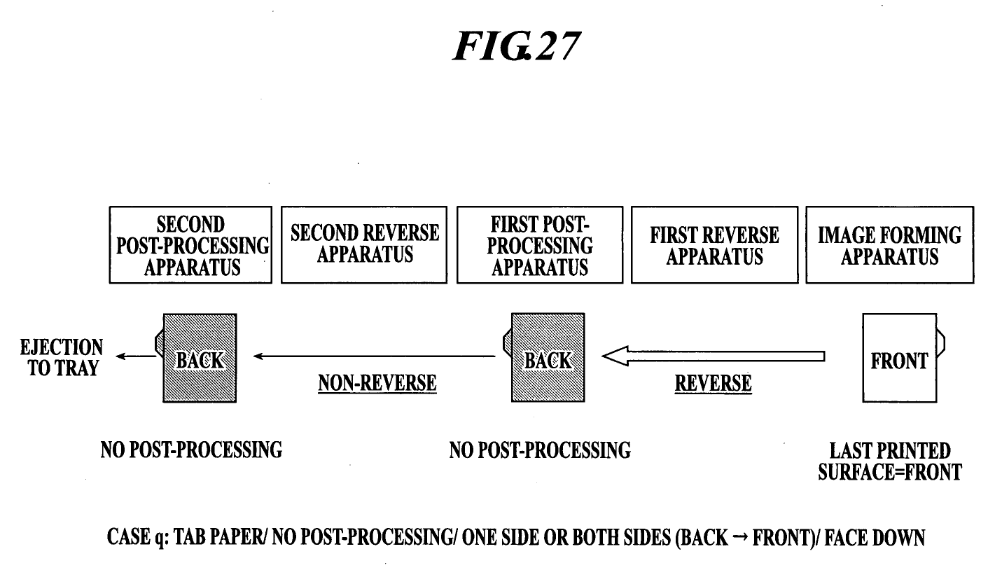

As shown in FIGS. 26 and 27, in a case q to lead the processing to Step S71, the paper is a sheet of tab paper, and the last printed surface is the front surface. In this case q, the front of the paper ejected from the image forming apparatus main body 100 is the surface on which image formation has been performed as the front surface.

Consequently, in the case q, because the reverse of the paper is performed in either of the first reverse apparatus 200 and the second reverse apparatus 400, the second post-processing apparatus 500 can eject the paper to the tray in the state of the face down.

As shown in FIGS. 8 and 9, in the judgments at Steps S61, S62, and S70 mentioned above, when it is judged that the instruction indicates no both side printing and the ejected paper surface is the face up (Step S61: NO, Step S70: NO), or when it is judged that the instruction indicates the both side printing, but the printing order is not the one from the front surface to the back surface, and the ejected paper surface is the face up (Step S61: YES, Step S62: NO, Step S70: NO), then control signals to perform no reverse of the paper in the first reverse apparatus 200 and the second reverse apparatus 400 are output to the first reverse apparatus 200 and the second reverse apparatus 400, respectively (Step S72).

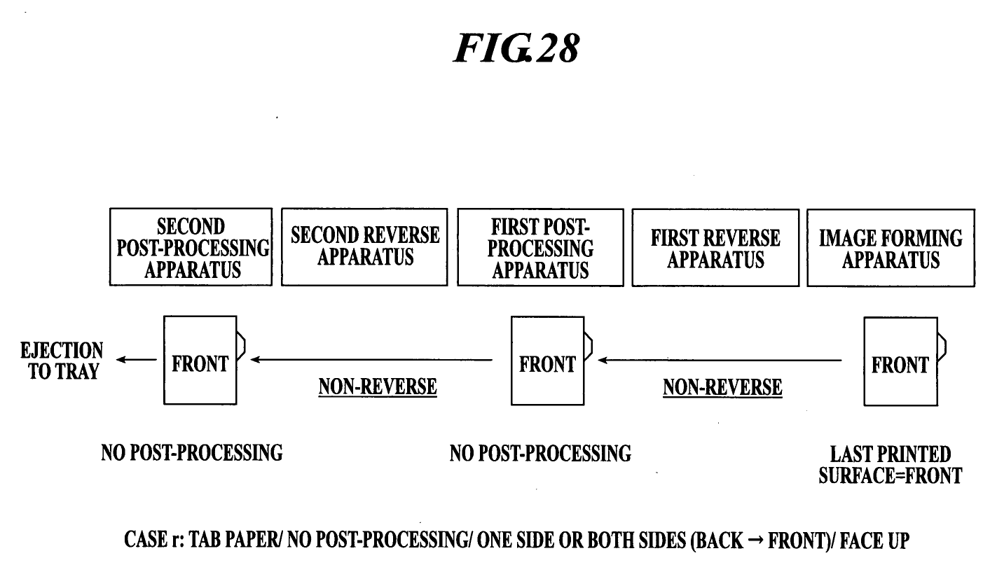

As shown in FIG. 28, in a case r to lead the processing to Step S72, the paper is a sheet of tab paper, and the last printed surface is the front surface. In this case r, the front of the paper ejected from the image forming apparatus main body 100 is the surface on which image formation has been performed as the front surface.

Consequently, in the case r, the second post-processing apparatus 500 can eject a sheet of paper ejected from the image forming apparatus main body 100 in the state of the face up by conveying the paper without reversing the paper in both of the first reverse apparatus 200 and the second reverse apparatus 400.

As described above, the image forming system 1 includes an instruction section (display/operation section 150) to perform an instruction pertaining to image formation; an image forming section (image forming section 130) to perform the image formation on a sheet of paper on a basis of the instruction by the instruction section; a first post-processing apparatus (first post-processing apparatus 300) to perform first post-processing to the paper after the image formation by the image forming section on a basis of the instruction by the instruction section; a second post-processing apparatus (second post-processing apparatus 500) to perform second post-processing to the paper routed through the first post-processing apparatus on a basis of the instruction by the instruction section; a first reverse apparatus (first reverse apparatus 200) to include a reverse mechanism to convey the paper from the image forming section to the first post-processing apparatus and to perform front-back reversing of the conveyed paper; a second reverse apparatus (second reverse apparatus 400) to include a reverse mechanism to convey the paper from the first post-processing apparatus to the second post-processing apparatus and to perform front-back reversing of the conveyed paper; and a control section (CPU 110) to control the front-back reversing of the paper in the first reverse apparatus and the second reverse apparatus on a basis of contents of the instruction of the instruction section.

Consequently, the image forming system 1 can control the front-back reversing of the sheet of paper in the first reverse apparatus to perform the front-back reversing of the paper at the time of conveying the paper to the first post-processing apparatus and in the second reverse apparatus to perform the front-back reversing of the paper at the time of conveying the paper to the second post-processing apparatus, on the basis of the instruction pertaining to the image formation by the instruction section. Consequently, the image forming system 1 can perform post-processing to the paper on which image formation has been performed by the first and second post-processing apparatus at the same time. Thereby, even when the image forming system 1 performs a plurality of pieces of post-processing, the image forming system 1 can reduce the work load of a user, and can improve the working efficiency of the user.

Moreover, the first post-processing apparatus of the image forming system 1 performs the first post-processing to a leading edge side of the paper after the image formation in a conveyance direction thereof, and the second post-processing apparatus performs the second post-processing to a rear edge side of the paper in the conveyance direction thereof.

Moreover, the first post-processing apparatus of the image forming system 1 performs the first post-processing to the rear edge side of the paper after the image formation in the conveyance direction thereof, and the second post-processing apparatus performs the second post-processing to the leading edge side of the paper in the conveyance direction thereof.

Consequently, even when the image forming system 1 is adapted so that the first post-processing apparatus and the second post-processing apparatus each perform the post-processing to the paper on the contrary side of the leading edge side in the conveyance direction, it is possible to perform the first and second post-processing to the same end side of the paper as the final ejection.

Moreover, the instruction section of the image forming system 1 instructs an assortment (such as stapling and punching holes) of the post-processing to be executed in the first post-processing apparatus and/or the second post-processing apparatus, and the control section of the image forming system 1 controls the reverse of paper in the first reverse apparatus and/or the second reverse apparatus on the basis of the assortment of the post-processing instructed by the instruction section.

Consequently, image forming system 1 can control the reverse of the paper in the first reverse apparatus and/or the second reverse apparatus on the basis of the assortment of the post-processing instructed by the instruction section. The image forming system 1 can use properly the case of performing the first and second post-processing in the case of performing only the first post-processing and in the case of performing only the second post-processing because the reverse of paper according to the assortment of the instructed post-processing is performed.

Moreover, the instruction section of the image forming system 1 instructs the image formation onto both sides or one side of a sheet of paper in the image forming section 1, and the control section of the image forming system 1 controls the reverse of the paper in the first reverse apparatus and/or the second reverse apparatus on the basis of the instruction of the image formation on the both sides or the one side instructed by the instruction section.

Consequently, the image forming system 1 can control the reverse of the paper in the first reverse apparatus and/or the second reverse apparatus on the basis of the instruction of the image formation to the both sides or the one side instructed by the instruction section. The image forming system 1 can simultaneously perform the post-processing by the first and second post-processing apparatus to the paper, the both sides or the one side of which the image formation has been performed because the reverse of the paper according to the instruction of the image formation to the both sides or the one side is performed.

Moreover, the control section of the image forming system 1 controls the reverse of the paper in the first reverse apparatus and/or the second reverse apparatus on the basis of the image formation order to the front and back surfaces of the paper when the image formation is performed to both the sides of the paper by the instruction by the instruction section.

Consequently, the image forming system 1 can control the reverse of the paper in the first reverse apparatus and/or the second reverse apparatus on the basis of the image formation order to the front and back surfaces of the paper in the case of performing the image formation on both the sides of the paper by the instruction of the instruction section. The image forming system 1 can simultaneously perform the post-processing by the first and second post-processing apparatus to the paper even when the image formation order to the paper is either one because the reverse of the paper is performed according to the image formation order at the time of performing the image formation on both the sides of the paper.

Moreover, the instruction section of the image forming system 1 instructs the ejected paper surface at the time of ejecting a sheet of paper to the outside of the machine, and the control section of the image forming system 1 controls the reverse of the paper in the first reverse apparatus and/or the second reverse apparatus on the basis of the ejected paper surface instructed by the instruction section.

Consequently, the image forming system 1 can controls the reverse of the paper in the first reverse apparatus and/or the second reverse apparatus on the basis of the ejected paper surface, instructed by the instruction section, at the time of ejecting the paper to the outside of the machine. The image forming system 1 can eject the paper with the ejected paper surface instructed because the reverse of the paper is performed according to the instructed ejected paper surface.

Moreover, the instruction section of the image forming system 1 instructs the assortment of the paper to be subjected to the image formation; the image forming section of the image forming system 1 performs the image formation to the paper of the assortment instructed by the instruction section; and the control section of the image forming system 1 controls the reverse of the paper in the first reverse apparatus and/or the second reverse apparatus on the basis of the assortment of the paper instructed by the instruction section. Consequently, the image forming system 1 can control the reverse of the paper in the first reverse apparatus and/or the second reverse apparatus on the basis of the assortment of the paper instructed by the instruction section.

Moreover, the instruction section of the image forming system 1 instructs the existence of a tab as the assortment of a sheet of paper, and the control section of the image forming system 1 controls the reverse of the paper in the first reverse apparatus and/or the second reverse apparatus on the basis of the existence of the tab instructed by the instruction section.

Consequently, the image forming system 1 can control the reverse of the paper in the first reverse apparatus and/or the second reverse apparatus on the basis of the existence of the tab of the paper instructed by the instruction section. The image forming system 1 can previously prevent, for example, the trouble to occur at the reverse of the paper owing to the existence of the because the reverse of the paper is performed according to the existence of the tab.

Moreover, the first reverse apparatus and/or the second reverse apparatus of the image forming system 1 include a paper stopper (such as the reverse stopper 421) to stay a plurality of sheets of paper, and reverse the plurality of sheets of paper stayed in the paper stopper. Consequently, the image forming system 1 can reverse the plurality of sheets of paper stayed in the paper stopper in the first reverse apparatus and/or the second reverse apparatus.

Moreover, the control section of the image forming system 1 controls the reverse of the paper in the first reverse apparatus and/or the second reverse apparatus on the basis of the existence of the paper stopper in the first reverse apparatus and/or the second reverse apparatus.

Consequently, the image forming system 1 can control the reverse of the paper in the first reverse apparatus and/or the second reverse apparatus on the basis of the existence of the paper stopper in the first reverse apparatus and/or the second reverse apparatus. The image forming system 1 can previously prevent, for example, the trouble (such as the collision of a tab with the paper stopper) to occur at the time of the reverse of the paper by the paper stopper because the reverse of the paper is performed according to the existence of the paper stopper in the first reverse apparatus and/or the second reverse apparatus.

Incidentally, the descriptions of the embodiment described above are examples, and the present invention is not the contents of the descriptions. The configurations and the operations of the embodiment described above can be suitably changed.

For example, in the present embodiment, although the image formation based on the instruction from the display/operation section 150 has been illustrated in the image forming system 1, the image formation may be the image formation based on an instruction from other information equipment such as a personal computer (PC). To put it concretely, the communication section 180 of the image forming apparatus main body 100 may be connected with a communication network such as the Internet and a local area network (LAN), and the image forming system 1 may include the function of a printer to perform the image formation on a sheet of paper on the basis of an instruction form other information equipment.

According to one aspect of the preferred embodiment of the present invention, there is provided an image forming system comprising:

an instruction section to perform an instruction pertaining to an image formation;

an image forming section to perform the image formation for a sheet of paper based on the instruction by the instruction section;

a first post-processing apparatus to perform first post-processing for the paper after the image formation by the image forming section, based on the instruction by the instruction section;

a second post-processing apparatus to perform second post-processing for the paper based on the instruction by the instruction section, the paper having been through the first post-processing apparatus;

a first reverse apparatus including a reverse mechanism to convey the paper from the image forming section to the first post-processing apparatus and to perform a reverse of the conveyed paper;

a second reverse apparatus including a reverse mechanism to convey the paper from the first post-processing apparatus to the second post-processing apparatus and to perform the reverse of the conveyed paper; and

a control section to control the reverse of the paper in the first reverse apparatus and in the second reverse apparatus based on contents of the instruction by the instruction section.

According to another aspect of the preferred embodiment of the present invention, there is provided an image forming apparatus comprising:

an instruction section to perform an instruction pertaining to an image formation;

an image forming section to perform the image formation for a sheet of paper based on the instruction by the instruction section;

a first post-processing section to perform first post-processing for the paper after the image formation by the image forming section, based on the instruction by the instruction section;

a second post-processing section to perform second post-processing for the paper based on the instruction by the instruction section, the paper having been through the first post-processing section;

a first reverse section including a reverse mechanism to convey the paper from the image forming section to the first post-processing section and to perform a reverse of the conveyed paper;

a second reverse section including a reverse mechanism to convey the paper from the first post-processing section to the second post-processing section and to perform the reverse of the conveyed paper; and

a control section to control the reverse of the paper in the first reverse section and in the second reverse section based on contents of the instruction by the instruction section.

The image forming system and the image forming apparatus can control the front-back reversing of a sheet of paper in the first reverse apparatus to perform the front-back reversing of the paper at the time of conveying the paper to the first post-processing apparatus and in the second reverse apparatus to perform the front-back reversing at the time of conveying the paper to the second post-processing apparatus on the basis of an instruction pertaining to the image formation in the instruction section, and can simultaneously perform the post-processing in the first and second post-processing apparatus. Consequently, even when a plurality of pieces of post-processing is performed, the work load of a user is reduced, and the working efficiency is improved.

Preferably, the first post-processing apparatus performs the first post-processing for the paper on a leading edge side thereof in a conveyance direction at a time of carrying in of the paper, the paper having been performed with the image formation, and

the second post-processing apparatus performs the second post-processing for the paper on a rear edge side thereof in the conveyance direction at the time of carrying in of the paper.

Preferably, the first post-processing apparatus performs the first post-processing for the paper on a rear edge side thereof in a conveyance direction at a time of carrying in of the paper, the paper having been performed with the image formation, and

the second post-processing apparatus performs the second post-processing for the paper on a leading edge side thereof in the conveyance direction at the time of carrying in of the paper.

Furthermore, even when the configuration is the one in which the first post-processing apparatus and the second post-processing apparatus each perform post-processing on the contrary side of the leading edge side of the paper in the conveyance direction thereof, the first and second post-processing can be performed on the same end side of the paper as a final ejection.

Preferably, the instruction section instructs an assortment of the post-processing to be executed in the first post-processing apparatus and/or the second post-processing apparatus, and

the control section controls the reverse of the paper in the first reverse apparatus and/or the second reverse apparatus based on the assortment of the post-processing, which is instructed by the instruction section.

Furthermore, the reverse of a sheet of paper in the first reverse apparatus and/or the second reverse apparatus can be controlled on the basis of the assortment of the post-processing instructed by the instruction section.

Preferably, the instruction section instructs the image forming section to perform the image formation for the paper on both sides or one side thereof, and

the control section controls the reverse of the paper in the first reverse apparatus and/or the second reverse apparatus based on the instruction of the image formation on the both sides or the one side, which is instructed by the instruction section.

Furthermore, the reverse of a sheet of paper in the first reverse apparatus and/or the second reverse apparatus can be controlled on the basis of the instruction of image formation to both sides or one side, which instruction has been instructed by the instruction section.

Preferably, the control section controls the reverse of the paper in the first reverse apparatus and/or the second reverse apparatus based on an image formation order of front and back surfaces of the paper, when the image formation is performed for the both sides of the paper based on the instruction by the instruction section.

Furthermore, when image formation is performed to the both sides of a sheet of paper based on an instruction by the instruction section, the reverse of the paper in the first reverse apparatus and/or the second reverse apparatus can be controlled on the basis of the image formation order to the front and back surfaces of the paper.

Preferably, the instruction section instructs an ejected paper surface at a time of ejecting the paper to an outside of the system, and

the control section controls the reverse of the paper in the first reverse apparatus and/or the second reverse apparatus based on the ejected paper surface instructed by the instruction section.

Furthermore, the reverse of a sheet of paper in the first reverse apparatus and/or the second reverse apparatus can be controlled on the basis of the ejected paper surface, instructed by the instruction section, at the time of the ejection of the paper to the outside of the machine.

Preferably, the instruction section instructs an assortment of the paper to be subjected to the image formation,

the image forming section performs the image formation for the paper of the assortment instructed by the instruction section, and

the control section controls the reverse of the paper in the first reverse apparatus and/or the second reverse apparatus based on the assortment of the paper instructed by the instruction section.

Furthermore, the reverse of a sheet of paper in the first reverse apparatus and/or the second reverse apparatus can be controlled on the basis of the assortment of the paper instructed by the instruction section.

Preferably, the instruction section instructs existence of a tab as the assortment of the paper, and

the control section controls the reverse of the paper in the first reverse apparatus and/or the second reverse apparatus based on the existence of the tab instructed by the instruction section.

Furthermore, the reverse of a sheet of paper in the first reverse apparatus and/or the second reverse apparatus can be controlled on the basis of the existence of the tab of the paper instructed by the instruction section.

Preferably, the first reverse apparatus and/or the second reverse apparatus comprises a paper stopper to stay a plurality of sheets of paper, and reverses the plurality of sheets of paper stayed by the paper stopper.

Furthermore, the first reverse apparatus and/or the second reverse apparatus can reverse a plurality of sheets of paper stayed by the paper stopper.

Preferably, the control section controls the reverse of the paper in the first reverse apparatus and/or the second reverse apparatus based on existence of the paper stopper in the first reverse apparatus and/or the second reverse apparatus.

Furthermore, the reverse of a sheet of paper in the first reverse apparatus and/or the second reverse apparatus can be controlled on the basis of the existence of the paper stopper in the first reverse apparatus and/or the second reverse apparatus.

The present U.S. patent application claims a priority under the Paris Convention of Japanese patent application No. 2007-259951 filed on Oct. 3, 2007, which shall be a basis of correction of an incorrect translation.

What is claimed is:

1. An image forming system comprising:
an instruction section to perform an instruction pertaining to an image formation;
an image forming section to perform the image formation for a sheet of paper based on the instruction by the instruction section;
a first post-processing apparatus to perform first post-processing for the paper after the image formation by the image forming section, based on the instruction by the instruction section;
a second post-processing apparatus to perform second post-processing for the paper based on the instruction by the instruction section, the paper having been through the first post-processing apparatus;
a first reverse apparatus including a reverse mechanism to convey the paper from the image forming section to the first post-processing apparatus and to perform a reverse of the conveyed paper;
a second reverse apparatus including a reverse mechanism to convey the paper from the first post-processing apparatus to the second post-processing apparatus and to perform the reverse of the conveyed paper; and
a control section to control the reverse of the paper in the first reverse apparatus and in the second reverse apparatus based on contents of the instruction by the instruction section.

2. The image forming system of claim 1, wherein the first post-processing apparatus performs the first post-processing for the paper on a leading edge side thereof in a conveyance direction at a time of carrying in of the paper, the paper having been performed with the image formation, and
the second post-processing apparatus performs the second post-processing for the paper on a rear edge side thereof in the conveyance direction at the time of carrying in of the paper.

3. The image forming system of claim 1, wherein the first post-processing apparatus performs the first post-processing for the paper on a rear edge side thereof in a conveyance direction at a time of carrying in of the paper, the paper having been performed with the image formation, and
the second post-processing apparatus performs the second post-processing for the paper on a leading edge side thereof in the conveyance direction at the time of carrying in of the paper.

4. The image forming system of claim 1, wherein the instruction section instructs an assortment of the post-processing to be executed in the first post-processing apparatus and/or the second post-processing apparatus, and
the control section controls the reverse of the paper in the first reverse apparatus and/or the second reverse apparatus based on the assortment of the post-processing, which is instructed by the instruction section.

5. The image forming system of claim 1, wherein the instruction section instructs the image forming section to perform the image formation for the paper on both sides or one side thereof, and
the control section controls the reverse of the paper in the first reverse apparatus and/or the second reverse apparatus based on the instruction of the image formation on the both sides or the one side, which is instructed by the instruction section.

6. The image forming system of claim 5, wherein the control section controls the reverse of the paper in the first reverse apparatus and/or the second reverse apparatus based on an image formation order of front and back surfaces of the paper, when the image formation is performed for the both sides of the paper based on the instruction by the instruction section.

7. The image forming system of claim 1, wherein the instruction section instructs an ejected paper surface at a time of ejecting the paper to an outside of the system, and
the control section controls the reverse of the paper in the first reverse apparatus and/or the second reverse apparatus based on the ejected paper surface instructed by the instruction section.

8. The image forming system of claim 1, wherein
the instruction section instructs an assortment of the paper to be subjected to the image formation,
the image forming section performs the image formation for the paper of the assortment instructed by the instruction section, and
the control section controls the reverse of the paper in the first reverse apparatus and/or the second reverse apparatus based on the assortment of the paper instructed by the instruction section.

9. The image forming system of claim 8, wherein
the instruction section instructs existence of a tab as the assortment of the paper, and
the control section controls the reverse of the paper in the first reverse apparatus and/or the second reverse apparatus based on the existence of the tab instructed by the instruction section.

10. The image forming system of claim 1, wherein the first reverse apparatus and/or the second reverse apparatus comprises a paper stopper to stay a plurality of sheets of paper, and reverses the plurality of sheets of paper stayed by the paper stopper.

11. The image forming system of claim 10, wherein the control section controls the reverse of the paper in the first reverse apparatus and/or the second reverse apparatus based on existence of the paper stopper in the first reverse apparatus and/or the second reverse apparatus.

12. An image forming apparatus comprising:
an instruction section to perform an instruction pertaining to an image formation;
an image forming section to perform the image formation for a sheet of paper based on the instruction by the instruction section;
a first post-processing section to perform first post-processing for the paper after the image formation by the image forming section, based on the instruction by the instruction section;
a second post-processing section to perform second post-processing for the paper based on the instruction by the instruction section, the paper having been through the first post-processing section;
a first reverse section including a reverse mechanism to convey the paper from the image forming section to the first post-processing section and to perform a reverse of the conveyed paper;
a second reverse section including a reverse mechanism to convey the paper from the first post-processing section to the second post-processing section and to perform the reverse of the conveyed paper; and
a control section to control the reverse of the paper in the first reverse section and in the second reverse section based on contents of the instruction by the instruction section.
